(19) United States
(12) Patent Application Publication
(10) Pub. No.: US 2016/0033059 A1
(43) Pub. Date: Feb. 4, 2016

(54) FLOWFORMING CORROSION RESISTANT ALLOY TUBES

(71) Applicant: ATI Properties, Inc., Albany, OR (US)

(72) Inventor: Matthew V. Fonte, Charlestown, MA (US)

(21) Appl. No.: 14/747,705

(22) Filed: Jun. 23, 2015

Related U.S. Application Data
(60) Provisional application No. 62/018,133, filed on Jun. 27, 2014.

(51) Int. Cl. F16L 9/17; C21D 8/10; C21D 9/08; C21D 6/00; C22F 1/00; C22F 1/10; C22F 1/18; C22C 38/58; C22C 38/44; C22C 38/42; C22C 38/04; C22C 38/00; C22C 19/05; F16L 9/02; B23K 26/21; B23K 9/16; B23K 10/02; B21C 37/08; B23K 31/02

(52) U.S. Cl. CPC F16L 9/17; B23K 31/027; C21D 8/105; C21D 9/085; C21D 6/004; C21D 6/005; C22F 1/002; C22F 1/10; C22F 1/183; C22C 38/58; C22C 38/44; C22C 38/42; C22C 38/04; C22C 38/001; C22C 19/058; C22C 19/056; C22C 19/055; F16L 9/02; B23K 26/21; B23K 9/16; B23K 10/02; B21C 37/08; B23K 2201/06

(57) ABSTRACT

Flowforming processes for the production of corrosion resistant alloy tubes are disclosed.

### CROSS-REFERENCE TO RELATED APPLICATIONS

This patent application is a non-provisional application filed under 35 U.S.C. §111(a) and claims priority under 35 U.S.C. §119(e) to U.S. Provisional Patent Application No. 62/018,133, filed on Jun. 27, 2014. U.S. Provisional Patent Application No. 62/018,133 is incorporated-by-reference into this specification.

### BACKGROUND

The information described in this background section is not admitted to be prior art.

“Oil country tubular goods” (OCTGs) are pipe and tube products used in the petroleum and natural gas industry. OCTGs include products such as drill pipe, casing pipe, and transport pipe.

Drill pipes are relatively heavy gauge tubes that rotate drill bits and circulate drilling fluid in petroleum and natural gas drilling operations. In operation, drill pipes are simultaneously subjected to high torque loads, longitudinal compression and tension loads, and internal pressure from drilling fluids. Additionally, alternating bending loads due to non-vertical or deflected drilling may be superimposed on these basic loading patterns. Casing pipes are used to line drilled boreholes. Casing pipes are subjected to longitudinal tension loads, internal pressure loads during fluid transport, and external pressure loads from surrounding rock formations. Transport pipes are tubes through which petroleum or natural gas is transported from a wellbore and are subjected to internal pressure loads.

Strength and corrosion resistance under sour (hydrogen sulfide-containing), acidic, and/or high temperature and pressure service conditions are important OCTG characteristics. Therefore, OCTGs are generally fabricated from high strength corrosion resistant alloys (CRAs).

### SUMMARY

This specification relates to processes for the production of corrosion resistant alloy tubes using flowforming operations. This specification also relates to corrosion resistant alloy tubes made using the processes described in this specification.

In one example, a process for the production of a tube comprises deforming a corrosion resistant alloy plate to form a hollow cylindrical preform having a longitudinal seam region located between two abutting ends of the deformed plate. The longitudinal seam region is welded to join together the abutting ends. The welded hollow cylindrical preform is flowformed to produce a corrosion resistant alloy tube.

In another example, a process for the production of a tube comprises deforming a stainless steel plate to form a hollow cylindrical preform having a longitudinal seam region located between two abutting ends of the deformed plate. The stainless steel comprises a duplex, super duplex, or hyper duplex stainless steel. The longitudinal seam region is laser welded to join together the abutting ends. The laser welded preform is annealed. The laser welded hollow cylindrical preform is flowformed at a cold working temperature to produce a stainless steel tube.

It is understood that the inventions described in this specification are not necessarily limited to the examples summarized in this Summary.

### BRIEF DESCRIPTION OF THE DRAWINGS

Various features and characteristics of the inventions described in this specification may be better understood by reference to the accompanying figures, in which:

FIG. 1A is a perspective view (not to scale) of an alloy plate; FIG. 1B is a perspective view (not to scale) of an open-seam hollow cylindrical preform made from the alloy plate shown in FIG. 1A; FIG. 1C is a perspective view (not to scale) of a closed-seam (welded) hollow cylindrical preform made from the open-seam preform shown in FIG. 1B;

FIGS. 2A and 2B are perspective and cross-sectional schematic diagrams, respectively, illustrating a three-roll plate bending apparatus deforming an alloy plate into an open-seam hollow cylindrical preform;

FIG. 3A shows a series of schematic diagrams representing a sequence of roll stands in a continuous roll forming operation; FIG. 3B is a schematic diagram of a roll forming mill in which a sequence of roll stands gradually shapes an alloy strip into an open-seam tube through a funnel-shaped forming line;

FIG. 4A is a perspective schematic diagram illustrating a U-press deforming an alloy plate into a U-shaped intermediate; FIG. 4B is a perspective schematic diagram illustrating an O-press deforming a U-shaped intermediate into an open-seam hollow cylindrical preform;

FIG. 5 is a cross-sectional schematic diagram illustrating a tube expanding operation radially expanding a closed-seam (welded) hollow cylindrical preform;

FIG. 6 is an isothermal precipitation diagram showing time-temperature-transformation curves for a first duplex stainless steel (Alloy 2205, corresponding to UNS Nos. S31803 and S32205), a second duplex stainless steel (Alloy 2304, corresponding to UNS No. S32304), and a super duplex stainless steel (Alloy 2507, corresponding to UNS Nos. S32750 and S32760), annealed at 1050° C. (1920° F.).

FIG. 7 is a perspective schematic diagram illustrating a flowforming apparatus;

FIG. 8 is a cross-sectional side schematic diagram illustrating a forward flowforming operation;

FIG. 9 is a cross-sectional side schematic diagram illustrating a reverse flowforming operation;

FIG. 10 is a perspective schematic diagram illustrating flowforming rollers;

FIG. 11 is a cross-sectional side schematic diagram illustrating the orientation of flowforming rollers and a workpiece in a flowforming operation;

FIG. 12 is a perspective schematic diagram illustrating a flowforming operation in which a closed-seam (welded) hollow cylindrical preform is deformed to produce a seamless tube;

FIG. 13 is an end schematic diagram illustrating a flowforming operation in which a closed-seam (welded) hollow cylindrical preform is deformed using a four roller configuration to produce a seamless tube;

FIG. 14A is a photograph showing a flowformed Alloy 625 tube (right side) and a rolled-and-welded Alloy 625 preform (left side) similar to the preform that was flowformed into the tube; FIG. 14B is a photograph showing the remaining weld seam on the driven end of the flowformed tube in FIG. 14A;

FIG. 15 is a photograph of rolled-and-welded Ti-15V-3Cr-3Sn-3Al alloy preforms;

FIG. 16 is a photograph of a partially flowformed Ti-15V-3Cr-3Sn-3Al alloy preform/tube; and

FIG. 17 is a photograph of rolled-and-welded super duplex stainless steel (UNS S32760) preforms.

The reader will appreciate the foregoing features and characteristics, as well as others, upon considering the following detailed description of the inventions according to this specification.

### DESCRIPTION

Oil and gas drilling and extraction operations are increasingly performed in deep well environments involving higher temperatures and pressures, and more corrosive and erosive conditions. In addition, enhanced recovery techniques such as hydraulic fracking, steam injection, carbon dioxide injection, fire flooding, and the like, are becoming commonplace in oil and gas operations and require reliable equipment with longer service lifetimes. The demanding environmental conditions and operating parameters that oil and gas drilling and extraction equipment operate under must be counterbalanced against weight reduction and other economic cost considerations. These considerations place practical limits on the materials of construction for oil and gas drilling and extraction equipment.

Consequently, OCTGs and other components of oil and gas drilling and extraction equipment may be fabricated from high strength CRAs such as, for example, martensitic stainless steels, martensitic/ferritic stainless steels, austenitic stainless steels, duplex (austenitic/ferritic) stainless steels, super duplex (austenitic/ferritic) stainless steels, hyper duplex (austenitic/ferritic) stainless steels, austenitic nickel base alloys, austenitic nickel base superalloys, and titanium base alloys. These CRAs provide a balance of material strength, toughness, corrosion resistance, formability, and cost-effectiveness that make the alloys suitable for OCTGs.

Large diameter tubes (e.g., tubes having outside diameters of at least 6.625 inches (168.3 mm)) represent a large portion of the OCTG market. However, prior processes for the production of large diameter tubes suffer from a number of shortcomings. For instance, prior seamless tube production processes, such as piercing and pilger rolling (Mannesmann) processes, piercing and plug rolling (Stiefel) processes, piercing and mandrel rolling processes, push bench processes, piercing and drawing processes, and hot-extrusion processes, are often incapable of producing CRA tube stock of sufficient size to produce finished tubes having a combination of large outside diameter, wall thickness, and length suitable for OCTGs.

Prior welded tube production processes also suffer from a number of shortcomings in the context of CRA tube production, including the inability to efficiently form and weld relatively large and thick CRA plate stock (e.g., lengths of at least 8 feet (2.4 meters), widths of at least 6.5 inches (165.1 mm), and thicknesses of at least 0.75 inches (19.1 mm)) into hollow cylindrical preforms. The ability to form and weld relatively large and thick CRA plate stock into hollow cylindrical preforms is important for the production of large diameter CRA tubes in a cold worked (cold hardened) condition, which requires downstream cold forming operations to achieve the strength properties required by OCTG specifications.

OCTGs are generally required to meet various industry standard specifications, including the American National Standards Institute/American Petroleum Institute Specification 5CRA, first edition, February 2010 (Specification for Corrosion Resistant Alloy Seamless tubes for Use as Casing, Tubing and Coupling Stock) (“ANSI/API Specification 5CRA”). ANSI/API Specification 5CRA is equivalent to ISO 13680:2008 (Modified). ANSI/API Specification 5CRA is incorporated-by-reference into this specification.

ANSI/API Specification 5CRA establishes a number of microstructural, mechanical, and compositional requirements, among other requirements, for OCTGs made from CRAs including martensitic stainless steels, martensitic/ferritic stainless steels, duplex (austenitic/ferritic) stainless steels, super duplex (austenitic/ferritic) stainless steels, austenitic stainless steels, and austenitic nickel base alloys. For instance, ANSI/API Specification 5CRA establishes requirements for, among other properties, room temperature yield strength (0.2% offset yield point), ultimate tensile strength, elongation, and HRC hardness number for OCTGs in various conditions applicable to specific CRAs (e.g., hot finished, quenched and tempered, solution annealed, or cold hardened).

The production of CRA tubes (especially large diameter cold hardened CRA tubes) that meet the requirements of ANSI/API Specification 5CRA has been found to be commercially impractical with prior welded tube production processes. However, the processes described in this specification may address and overcome this commercial impracticability and produce welded and seamless cold worked (cold hardened) CRA tubes (including, but not limited to, large diameter tubes) that may meet the requirements of ANSI/API Specification 5CRA.

A process for the production of a tube comprises deforming an alloy plate to form a hollow cylindrical preform. The hollow cylindrical preform is initially an open-seam preform having a longitudinal seam region located between two abutting ends of the cylindrically deformed plate. The longitudinal seam region is welded to join together the abutting ends and form a closed-seam preform. The closed-seam (welded) hollow cylindrical preform may be radially expanded. The closed-seam (optionally expanded) preform is flowformed to provide a seamless cold worked (cold hardened) alloy tube.

As used herein, the term “tube” refers to any hollow cylindrical tubular article. Accordingly, the term “tube” encompasses and includes pipes and other conduits comprising an annular-shaped cross-section regardless of dimensions.

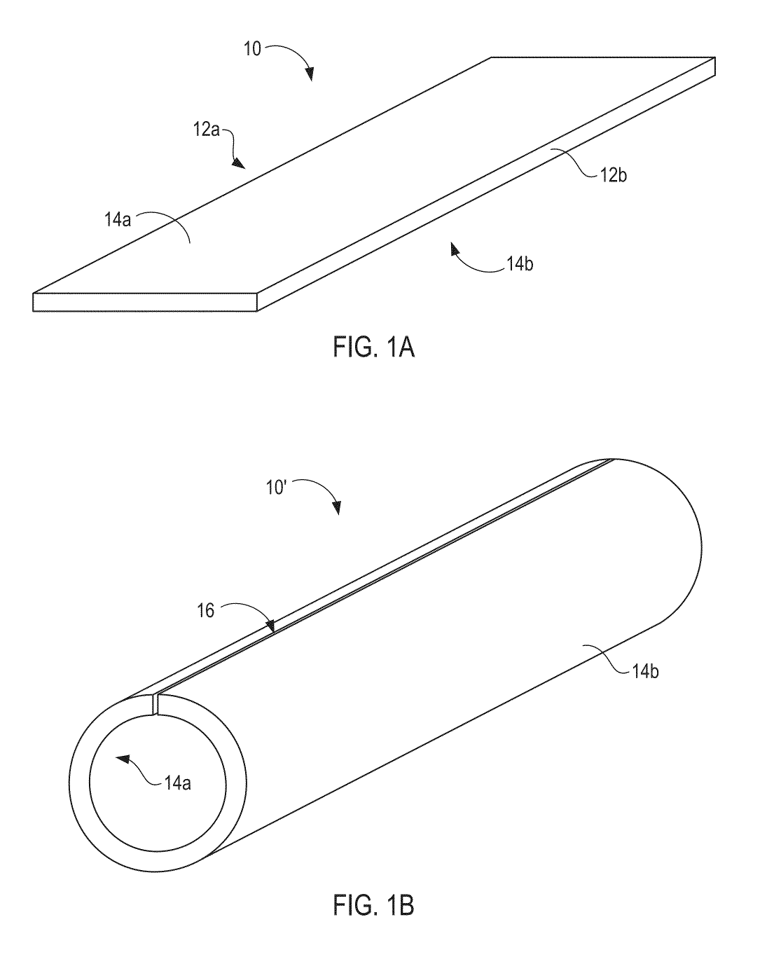

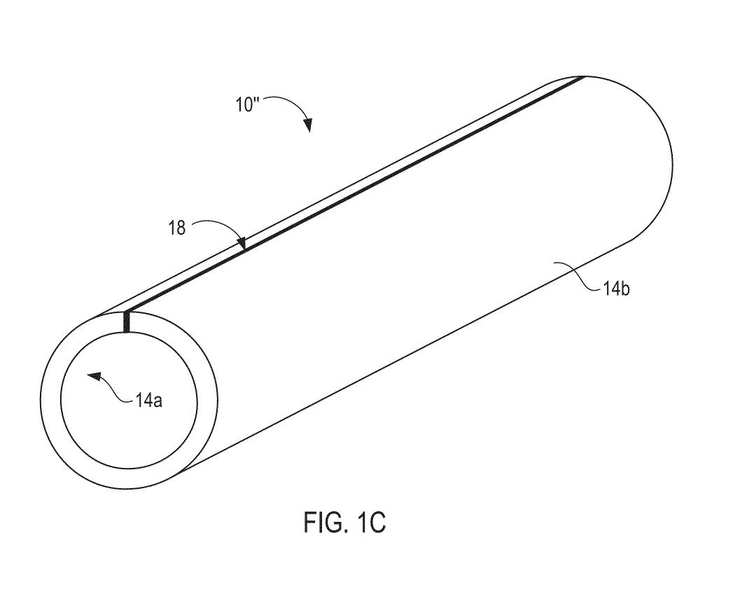

Referring to FIG. 1A, a rectangular alloy plate 10 has opposed longitudinal ends 12a and 12b, and opposed major surfaces 14a and 14b. The alloy plate 10 is deformed into a hollow cylindrical preform 10′, as shown in FIG. 1B. The hollow cylindrical preform 10′ is an open-seam preform having a longitudinal seam region 16 located between the abutting longitudinal ends 12a and 12b. As used herein, the term “open-seam” refers to the initially un-welded condition of the longitudinal region located between the abutting longitudinal ends of a cylindrically deformed plate, and the term “closed-seam” refers to the subsequently welded condition of the longitudinal region. An open-seam preform may have abutting longitudinal ends in physical contact or with a small gap between the abutting longitudinal ends.

For sake of illustration, the longitudinal seam region 16 is shown in FIG. 1B with a gap between abutting longitudinal ends 12a and 12b. It is to be understood that, in practice, any gap between the abutting longitudinal ends should be sufficiently small to permit the subsequent welding together of the abutting longitudinal ends. Accordingly, as used herein, the term “abutting” refers to either direct physical contact or a facing orientation in which the gap between facing longitudinal ends is sufficiently small to permit the subsequent welding together of the abutting longitudinal ends. The size of any gap between abutting longitudinal ends in a seam region may be dictated by the welding technique used to join together the longitudinal ends.

The longitudinal seam region 16 is welded to join together the abutting ends 12a and 12b and form a closed-seam preform 10″, as shown in FIG. 1C. The closed-seam hollow cylindrical preform 10″ comprises a welded seam 18 joining together the ends 12a and 12b.

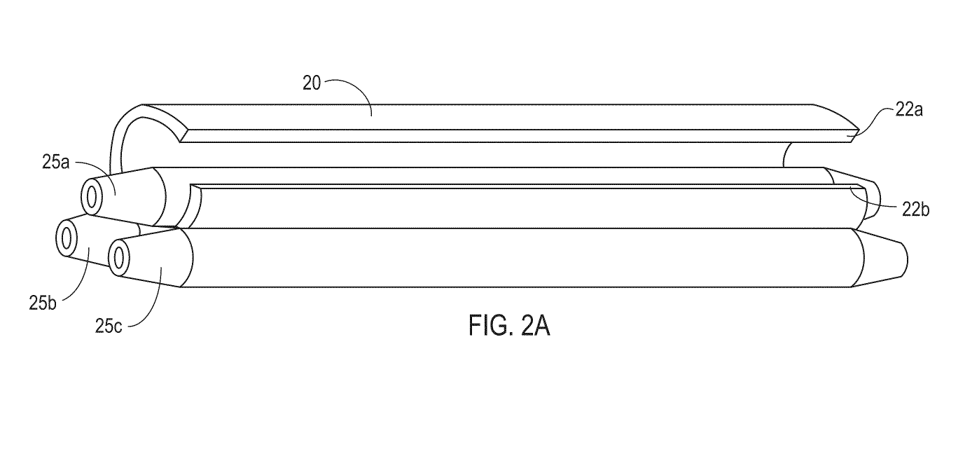

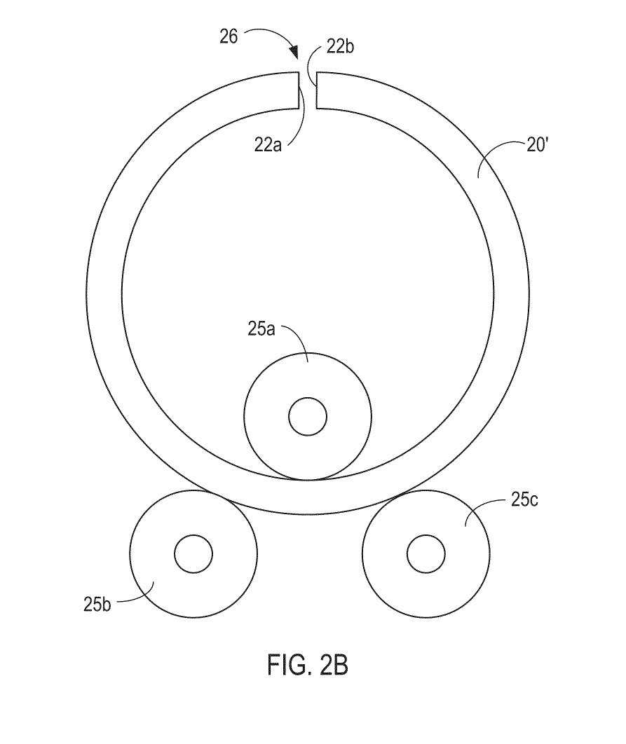

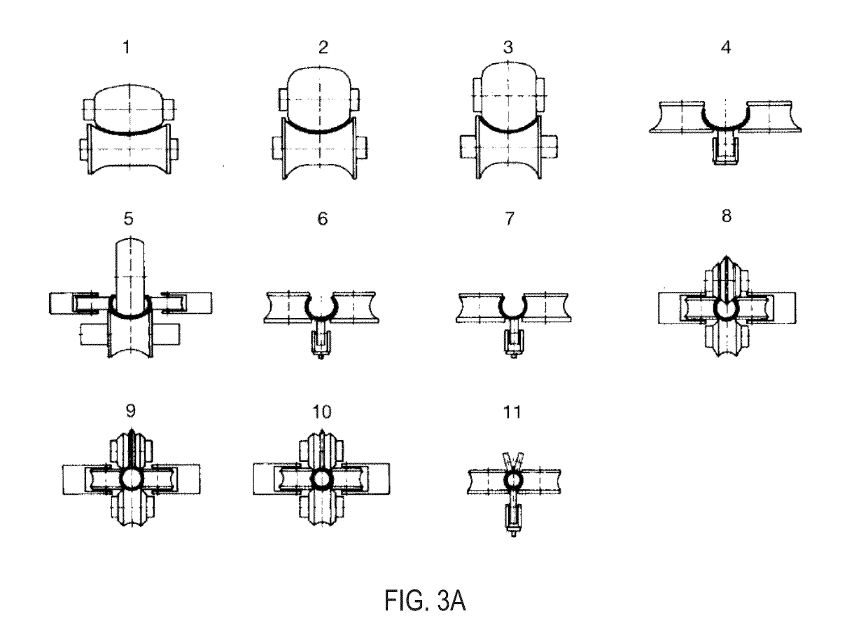

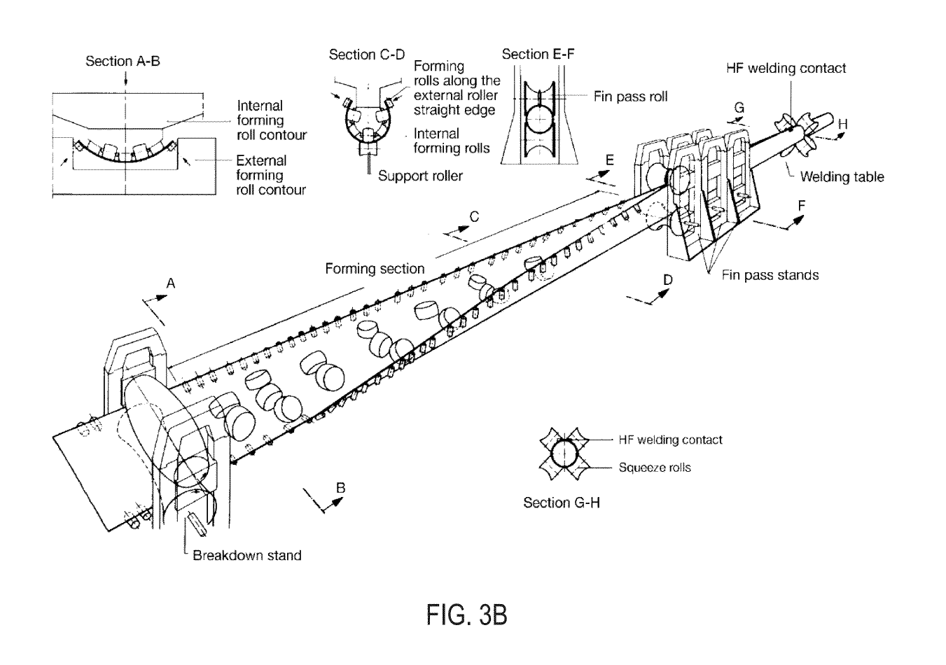

The deforming of an alloy plate to form an open-seam hollow cylindrical preform may be performed using a roll bending operation. As used herein, the term “roll bending” refers to the bending of a single alloy plate in a batch operation (one plate at a time) using, for example, a three-roll bending apparatus or similar equipment. For example, FIGS. 2A and 2B schematically illustrate the formation of an open-seam hollow cylindrical preform 20′ having a longitudinal seam region 26 located between abutting ends 22a and 22b of a deformed plate 20 in a three-roll bending apparatus comprising rolls 25a, 25b, and 25c. “Roll bending,” as used herein, is distinct from roll forming in which a continuous alloy strip is fed through a roll forming mill in which a sequence of roll stands gradually shapes the strip into an open-seam tube through a funnel-shaped forming line (see FIGS. 3A and 3B). In various embodiments, roll forming operations (including continuous and/or high speed roll forming operations, such as those described in U.S. Pat. No. 6,880,220 to Gandy, for example) may be unsuitable for the production of preforms because roll forming mills may be incapable of plastically deforming large and thick plate stock (e.g., thicknesses of at least 0.75 inches (19.1 mm)) into hollow cylindrical preforms.

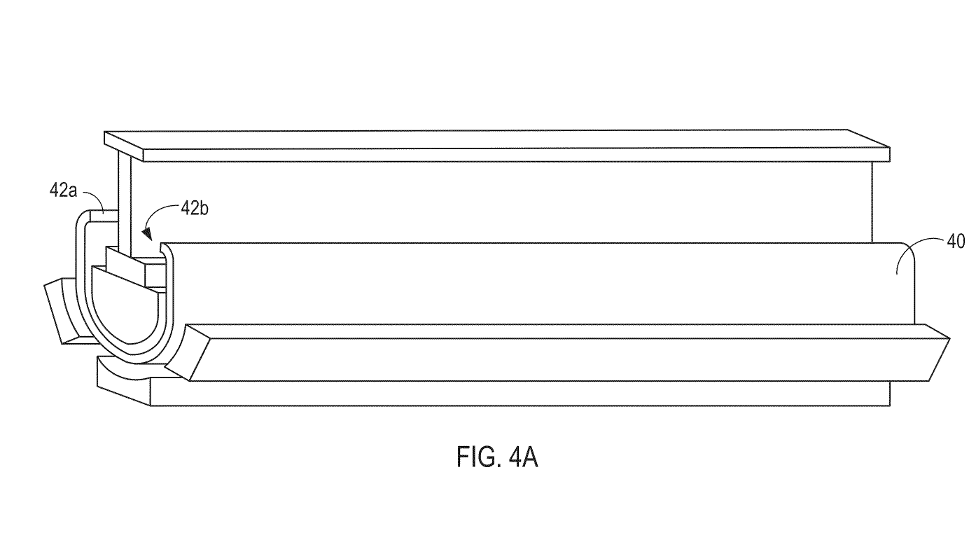

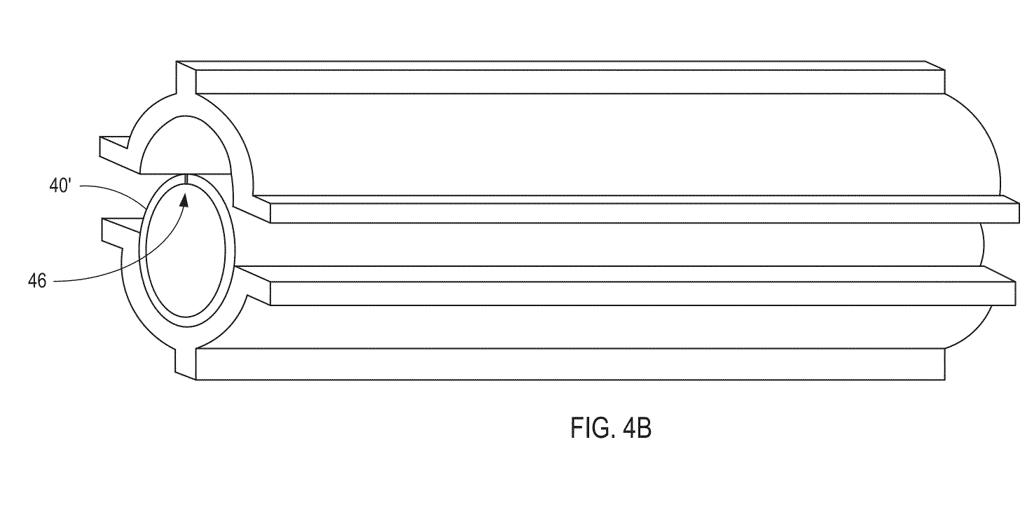

The deforming of an alloy plate to form an open-seam hollow cylindrical preform may be performed using a U-O pressing operation. As used herein, the term “U-O pressing” refers to the sequential pressing of plate stock in a U-press to form a cross-sectional U-shaped intermediate, followed by pressing of the U-shaped intermediate in an O-press to form a cross-sectional O-shaped open-seam hollow cylindrical preform. For example, FIG. 4A schematically illustrates the pressing of a plate in a U-press to form a U-shaped intermediate 40 having longitudinal ends 42a and 42b, and FIG. 4B schematically illustrates the subsequent pressing of the U-shaped intermediate in an O-press to form an open-seam hollow cylindrical preform 40′ having a longitudinal seam region 46 located between the abutting longitudinal ends 42a and 42b.

In a U-pressing operation, a circular radius tool pushes a plate down between two supports, often in a single press stroke. Toward the end of the operation, the distance between the two supports may be reduced to apply a small degree of overbend to counter any spring-back effect. In a subsequent O-pressing operation, the U-shaped intermediate is formed into an O-shaped preform, usually in a single press stroke. The deformation operations performed in a U-O pressing operation are coordinated to ensure that the spring-back effect is effectively countered and the open-seam preform is as circular as possible with the abutting longitudinal ends as flush as possible. In various embodiments, a U-O pressing operation may be preceded by a C-pressing operation in which a rectangular plate is first pressed into a cross-sectional C-shaped intermediate in a C-press, the C-shaped intermediate is pressed into a cross-sectional U-shaped intermediate in a U-press, and the U-shaped intermediate is pressed into a cross-sectional O-shaped open-seam hollow cylindrical preform in an O-press.

The roll bending and U-O pressing operations described above are exemplary techniques for the deforming of an alloy plate into an open-seam hollow cylindrical preform. The deforming may also be performed using other press forming operations having the capability to deform relatively thick alloy plates into open-seam hollow cylindrical preforms.

The deforming of an alloy plate to form an open-seam hollow cylindrical preform may be performed at a cold working temperature. As used herein, the term “cold working temperature” refers to temperatures that are less than the recrystallization temperature of an alloy. In various embodiments, an alloy plate may be deformed into an open-seam hollow cylindrical preform at a cold working temperature that is less than 500° C., less than 400° C., less than 300° C., less than 200° C., or less than 100° C. In various embodiments, an alloy plate may be deformed into an open-seam hollow cylindrical preform at room temperature (i.e., the temperature at the start of the deforming operation and not accounting for adiabatic heating during plastic deformation).

In various embodiments, the open-seam hollow cylindrical preform is formed from a plate such that the grains of the alloy material are substantially oriented in the longitudinal direction of the preform. This may be accomplished, for example, by providing rectangular alloy plates having grains substantially oriented along the length (longitudinal edge direction) of the plate, which may be provided by warm or hot rolling slabs or intermediate plates to a final plate thickness, wherein the rolling direction coincides with the length (long dimension) of the plate. As used herein, the term “substantially oriented” refers to the alloy texture condition in which the majority of the long axes of the constituent grains are inclined toward one of the three cardinal directions (length, width, thickness). Whether the grains of a given alloy specimen are “substantially oriented” in a particular direction can be metallographically determined using microscopy images. Substantially orienting the grains of the alloy material in the longitudinal direction of the preform may provide for more efficient and effective flowforming operations.

The alloy plates that are deformed into open-seam hollow cylindrical preforms may be provided by hot rolling operations. Alloy feedstock materials may be melted to provide a predetermined alloy chemistry and the molten material cast into an ingot or slab in a metallurgy operation. Examples of metallurgy operations suitable for providing cast CRAs include, for example, continuous slab casting, vacuum induction melting (VIM) and ingot casting, and electric arc melting and ingot casting. Intermediate refining operations may also be employed including, for example, argon oxygen decarburization (AOD), vacuum oxygen decarburization (VOD), electroslag refining/remelting (ESR), and/or vacuum arc remelting (VAR). A cast alloy ingot may be hot forged (i.e., forged above the recrystallization temperature of the alloy) to a slab or other mill product form suitable for rolling. A cast slab may be rolled directly.

Cast or hot forged alloy slabs (often 6-12 inches (152.4-308.4 mm) thick) may be heated to temperatures above the recrystallization temperature of the alloy and rolled to plate thicknesses, such as, for example, 0.5 inch to 1.75 inch (12.7-44.5 mm). The rolled slabs elongate in the rolling direction, which generally coincides with the length (long dimension) of the plates formed in the hot rolling operations, and therefore the grains in the alloy plates are substantially oriented along the length (longitudinal edge direction) of the plates. Hot rolled plates may be cut to appropriate rectangular dimensions, such as, for example, lengths of at least 8 feet (2.4 meters) and widths of at least 6.5 inches (165.1 mm). The hot rolled plates may then be directly deformed into open-seam hollow cylindrical preforms in roll bending, U-O pressing, or other suitable forming operations. The plates used to form the open-seam hollow cylindrical preforms may be used in a hot-worked condition, which is generally similar to a softened annealed condition, because the subsequent flowforming operations can refine the grain structure of the alloy material.

Before the deforming of an alloy plate into an open-seam hollow cylindrical preform, the alloy plate may be ground or machined. The major top and bottom surfaces of a plate may be ground or machined to increase the flatness of the plate. For example, the major top and bottom surfaces of the plate may be ground or machined to ensure that the plate exhibits a flatness of at least ±0.020 inch (±0.508 mm). The longitudinal ends and/or the transverse ends of a rectangular plate may also be ground or machined before deformation to ensure that opposed ends are parallel and that the longitudinal ends are perpendicular to the transverse ends. The opposed longitudinal ends of a plate may also be machined before deformation to provide an appropriate welding bevel on the ends.

Before the deforming of an alloy plate into an open-seam hollow cylindrical preform, the longitudinal ends of the alloy plate may be pre-bent in an edge bending (crimping) press. The edge bending radius formed in a plate in a bending (crimping) press may generally correspond to a predetermined diameter of the subsequently-formed open-seam hollow cylindrical preform.

After the forming of an open-seam hollow cylindrical preform and before the welding of the longitudinal seam region to join together the abutting ends, the longitudinal seam region may be tack welded at discrete locations along the length of the seam region. For example, the abutting ends may be pressed together into physical contact in a tack welding stand and tack welded at discrete locations along the length of the seam region to close any gap between the abutting ends. The tack welded hollow cylindrical preform may then undergo a subsequent welding operation to fully weld the longitudinal seam region.

The longitudinal seam region of an open-seam hollow cylindrical preform may be welded using a welding technique such as, for example, tungsten inert gas welding (TIG), metal inert gas welding (MIG), plasma arc welding, friction-stirred welding, electron beam welding, or laser welding. In various embodiments, the longitudinal seam region is welded using a filler-less welding technique, such as laser welding, for example, which does not deposit any additional weld alloy in the seam region. The welding of the longitudinal seam region may comprise two passes: an outside pass along the seam region on the outside surface of the preform; and an inside pass along the seam region on the inside surface of the preform.

In embodiments comprising a welding technique that uses filler material, the composition of the weld alloy may be the same as or similar to the constituent alloy of the plate/preform. For example, TIG or MIG welding operations may use a filler wire or consumable electrode made of a weld alloy composition that is the same as or similar to the constituent alloy of the plate/preform. In some embodiments, a weld alloy may be over-alloyed with at least one austenite stabilizing element (e.g., nickel, manganese, copper, nitrogen, and/or carbon). The level of over-alloying in a weld alloy may be designed or selected to ensure that the chemical composition and microstructure of the welded seam in a preform remains in specification for the constituent alloy of the plate/preform. For example, in embodiments comprising a duplex or super duplex stainless steel preform, a duplex or super duplex stainless steel weld alloy may be used in a TIG, MIG, or plasma arc welding operation to close the longitudinal seam. The chemical composition of the duplex or super duplex stainless steel weld alloy may be slightly over-alloyed with nickel or manganese, for example, but still within specification for the duplex or super duplex stainless steel of the preform.

The welding of the longitudinal seam region may optionally be performed in a nitrogen gas atmosphere. For example, a nitrogen gas atmosphere may be provided by nitrogen shield gas flowing from nozzles directed toward a longitudinal seam region during a welding pass on a hollow cylindrical preform. Laser welding operations, for example, produce very limited heat affected zones and rapid cooling of the welded longitudinal seam region, which reduces or prevents the formation of intermetallic phases. However, the high cooling rate associated with laser welding may result in excessive ferrite formation in the weld zone when laser welding duplex, super duplex, or hyper duplex stainless steels. Nitrogen is an austenite stabilizing element and, therefore, laser welding in a nitrogen gas atmosphere may aid in maintaining the relative proportions of austenite and ferrite in the weld zone in embodiments comprising duplex, super duplex, or hyper duplex stainless steel CRAs.

During the welding of the longitudinal seam region, weld kerf (also known as weld bead) may form along the welded seam. The weld kerf/bead may be removed using a burnishing operation, a skiving (cutting) operation, a machining operation, a grinding operation, or a planishing operation for example. Weld kerf/bead may also be smoothed out using a rolling operation as described, for example, in U.S. Pat. No. 6,375,059, which is incorporated-by-reference into this specification.

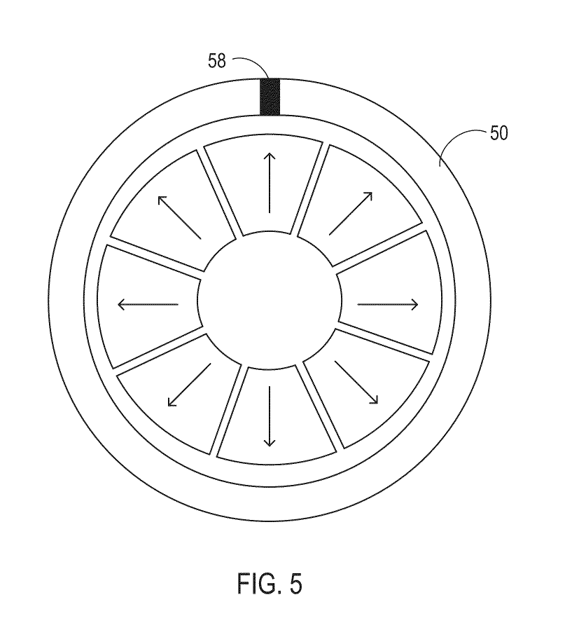

The closed-seam (welded) hollow cylindrical preform may optionally be radially expanded before flowforming. Radial expansion of the welded hollow cylindrical preform may be performed using a hydraulic or mechanical expander. FIG. 5 schematically illustrates the radial expansion of a closed-seam hollow cylindrical preform 50 comprising a welded longitudinal seam 58. Radially expanding the closed-seam (welded) hollow cylindrical preform plastically deforms the alloy material and increases the cross-sectional roundness and longitudinal straightness of the preform, which may facilitate subsequent flowforming operations.

A closed-seam (welded) hollow cylindrical preform may be radially expanded by at least 0.5% of the initial inside diameter of the preform. For example, a preform may be expanded by at least 1%, at least 1.5%, or at least 2% of the initial inside diameter of the preform. A closed-seam (welded) hollow cylindrical preform may be expanded by no greater than 6% of the initial inside diameter of the preform. For example, a preform may be expanded by no greater than 5%, no greater than 4%, or no greater than 3% of the initial inside diameter of the preform. Generally, the amount of radial expansion, if any, may be the minimum necessary to achieve sufficient roundness and straightness to meet flowforming tolerances. The amount of expansion should avoid splitting the welded seam and avoid cold working/cold hardening the alloy material.

The optional expanding of a closed-seam (welded) hollow cylindrical preform may be performed at a temperature less than 500° C. For example, the radial expanding may be performed at a temperature that is less than 500° C., less than 400° C., less than 300° C., less than 200° C., or less than 100° C. The radial expanding may be performed at room temperature.

After the welding operation and before the flowforming operation, the closed-seam (welded) hollow cylindrical preform may optionally be annealed. In embodiments comprising an optional expanding operation, an optional annealing operation may be performed after the welding operation and either before the expanding operation or between the expanding operation and the flowforming operation. A suitable annealing temperature may be selected based on the identity of the alloy material of the preform.

For example, duplex stainless steel preforms may be annealed at a temperature in the range of 875° C. to 1200° C. (1607-2192° F.), or any sub-range subsumed therein, such as, for example, 1010° C.-1177° C. (1850-2150° F.), 982° C. to 1149° C. (1800-2100° F.), 950° C. to 1150° C. (1742-2102° F.), or 1000° C. to 1100° C. (1832-2012° C.). Super duplex and hyper duplex stainless steel preforms, for example, may be annealed at a temperature in the range of 950° C. to 1200° C. (1742-2192° F.), or any sub-range subsumed therein, such as, for example, 1010° C.-1177° C. (1850-2150° F.), 982° C. to 1149° C. (1800-2100° F.), 1050° C. to 1150° C. (1922-2102° F.), or 1075° C. to 1100° C. (1967-2012° F.). Generally, for duplex, super duplex, and hyper duplex stainless steels, annealing at suitable higher temperatures tends to increase the ferrite content compared with annealing at suitable lower temperatures.

As used herein, heating a preform for a specified period of time or time range “at” a specified temperature or temperature range (i.e., time-at-temperature) indicates heating the preform for the specified time or time range measured from the point when the surface temperature of the preform (measured, for example, using a thermocouple, pyrometer, or the like) reaches ±14° C. (±25° F.) of the specified temperature or temperature range. As used herein, a specified time-at-temperature does not include the pre-heating time to bring the surface temperature of the preform to within ±25° F. (±14° C.) of the specified temperature or temperature range. As used herein, the term “furnace time” indicates the amount of time that a workpiece is maintained inside a controlled temperature environment such as, for example, a pre-heated furnace, and does not include the time needed to bring the controlled temperature environment to the specified temperature or temperature range.

Annealing treatments may be performed at temperatures above the recrystallization temperature of the alloy (including the alloy of the deformed plate and any weld alloy that may be used to close the longitudinal seam of the deformed plate). Annealing treatments may recrystallize at least the heat-affected zone of the welded preform, may recrystallize a larger portion of the welded preform, or may recrystallize the entire welded preform.

Annealing treatments may be performed by heating the preform to a surface temperature in an annealing temperature range and then maintaining the preform for a predetermined time-at-temperature before cooling the preform (e.g., by removing the preform from an annealing furnace). For example, a preform may be heated to a specified surface temperature in an annealing temperature range and then maintained at temperature for at least 5 minutes, at least 10 minutes, at least 15 minutes, at least 20 minutes, at least 25 minutes, or at least 30 minutes (time-at-temperature). Alternatively, annealing treatments may be performed by placing the preform in an annealing furnace (or other controlled temperature environment) operating at temperature and then maintaining the preform in the furnace for a predetermined furnace time before cooling the preform (e.g., by removing the preform from the annealing furnace). For example, a preform may be placed into an annealing furnace operating at a specified temperature in an annealing temperature range and then maintained in the furnace for at least 5 minutes, at least 10 minutes, at least 15 minutes, at least 20 minutes, at least 25 minutes, or at least 30 minutes (furnace time). A preform may be maintained at temperature or in an operating furnace for a period of time not to exceed, for example, 60 minutes, 45 minutes, 30 minutes, or 15 minutes (time-at-temperature or furnace time, as the case may be).

In embodiments comprising an optional annealing operation, the annealed preform may be quenched from annealing temperatures after a specified time-at-temperature or furnace time. For example, a preform may be quenched from an annealing temperature after no more than 30 minutes, no more than 25 minutes, no more than 20 minutes, or no more than 15 minutes (time-at-temperature or furnace time, as the case may be). Quenching may be performed at a cooling rate that prevents the precipitation of deleterious phases during the cooling. Such cooling rates may be achieved, for example, using a water quenching operation.

In duplex, super duplex, and hyper duplex stainless steels, for example, deleterious sigma phases, chi phases, alpha prime phases, carbides, and/or nitrides may rapidly form in a matter of minutes at certain temperatures. For example, typical temperatures for precipitation reactions and other characteristic reactions in a duplex (UNS S31803 and S32205) and super duplex (UNS S32750 and S32760) stainless steel are shown in Table 1.

TABLE 1

| | UNS S31803 and S32205 | | UNS S32750 and S32760 | |
|---|---|---|---|---|
| | ° C. | ° F. | ° C. | ° F. |
| Solidification range | 1445-1385 | 2630-2525 | 1450-1390 | 2640-2535 |
| Scaling in air | 1000 | 1830 | 1000 | 1830 |
| Sigma and chi phase | 700-975 | 1300-1800 | 700-975 | 1300-1800 |
| formation | | | | |
| Carbide and nitride | 450-800 | 840-1470 | 450-800 | 840-1470 |
| precipitation | | | | |
| 475° C./885° F. | 350-525 | 650-980 | 350-525 | 650-980 |
| embrittlement | | | | |

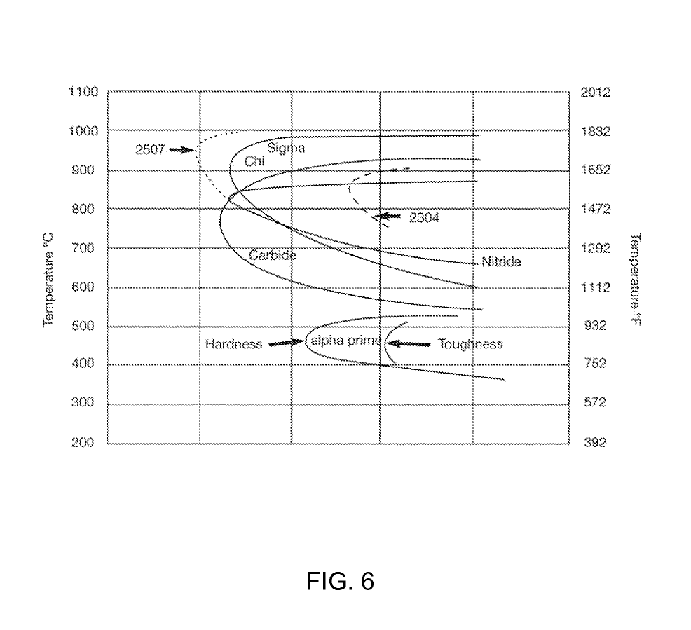

FIG. 6 is an isothermal precipitation diagram showing time-temperature-transformation curves for a first duplex stainless steel (Alloy 2205, corresponding to UNS Nos. S31803 and S32205), a second duplex stainless steel (Alloy 2304, corresponding to UNS No. S32304), and a super duplex stainless steel (Alloy 2507, corresponding to UNS Nos. S32750 and S32760), annealed at 1050° C. (1920° F.). FIG. 6 shows the temperature ranges and kinetics of deleterious phase formation. Carbide and nitride precipitation can begin quickly as 1-2 minutes at temperature. Sigma and chi phase precipitation occurs at higher temperatures but at approximately the same time as carbide and nitride precipitation. Duplex and super duplex stainless steels that are more highly alloyed in chromium, molybdenum, and nickel will have more rapid sigma and chi phase formation kinetics than lower alloyed duplex stainless steels. The formation of alpha prime precipitates at lower temperatures can undesirably harden and embrittle the ferrite in duplex and super duplex stainless steels.

Exposures of a few minutes in the temperature ranges noted above may result in the formation of phases detrimental to corrosion resistance and toughness. Allowing a preform to cool from annealing temperatures into a 700-980° C. (1300-1800° F.) temperature range before relatively rapid quenching (e.g., by water quenching) may also lead to the formation of detrimental phases. Therefore, in various embodiments, preforms may be quenched from annealing temperatures at cooling rates sufficient to prevent the formation of detrimental phases using, for example, a water quenching operation.

The closed-seam (welded) hollow cylindrical preform is flowformed to provide a seamless cold worked (cold hardened) alloy tube. Flowforming is a metal forming operation used to produce precise cylindrical components. Flowforming is typically performed by compressing the outer diameter of a cylindrical workpiece over an inner, rotating mandrel using a combination of axial, radial, and tangential forces from two or more rollers. The material is compressed above its yield strength, causing plastic deformation of the material. As a result, the outer diameter and the wall thickness of the workpiece are decreased, while its length is increased, until the desired geometry of the component is achieved.

Flowforming is generally a cold-forming operation performed at cold working temperatures. Although adiabatic heat is generated from the plastic deformation, the workpiece, mandrel, and rollers are typically flooded with a refrigerated coolant to dissipate the heat. This ensures that the material is worked well below its recrystallization temperature. Being a cold-forming process, flowforming increases the workpiece material's strength and hardness, imparts texture to the material, and often achieves mechanical properties and dimensional accuracies that are far closer to requirements than achieved with any warm or hot forming manufacturing processes.

Two examples of flowforming operations are forward flowforming and reverse flowforming. Generally, forward flowforming is useful for forming tubes or components having at least one closed or semi-closed end (e.g., a closed cylinder). Reverse flowforming is generally useful for forming tubes or components that have two open ends (e.g., a cylinder having two open ends). In some cases, a combination of forward and reverse flowforming may be utilized to successfully achieve desired geometry. Typically, forward flowforming and reverse flowforming may be performed on the same flowforming machine by changing the necessary tooling.

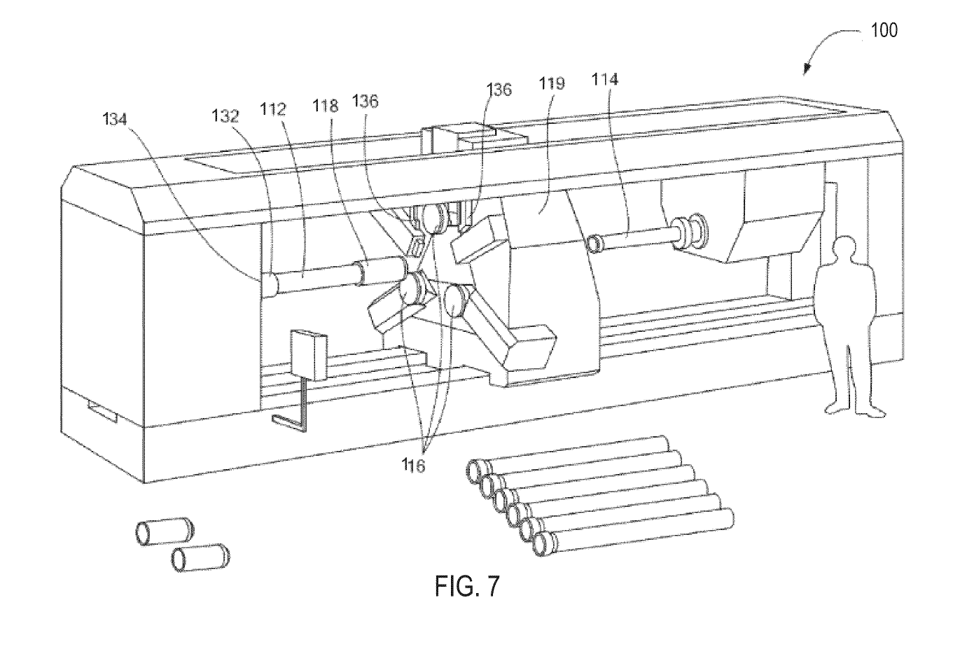

FIG. 7 schematically illustrates a flowforming device 100. The flowforming device 100 is configured for forward flowforming. The flowforming device 100 includes a mandrel 112 for holding a cylindrical workpiece 118, a tailstock 114 that secures the workpiece 118 to the mandrel 112, two or more rollers 116 for applying force to the outer surface of the workpiece 118, and a movable carriage 119 coupled to the rollers 116. As shown in FIG. 7, the rollers 116 may be angularly equidistant from each other relative to the center axis of the workpiece 118. The rollers 116 may be hydraulically-driven and computer numerical controlled (CNC).

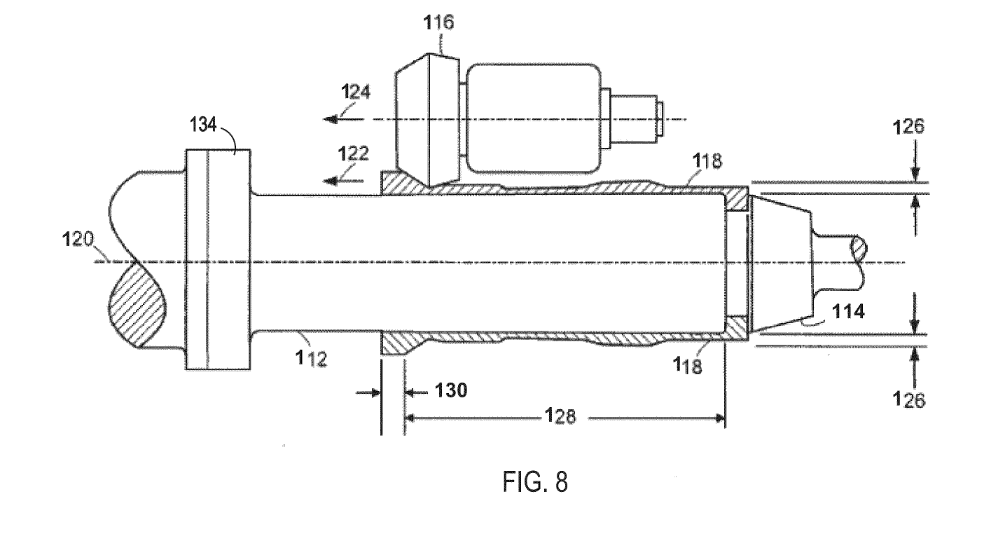

FIG. 8 shows a schematic cross-sectional side view of a workpiece 118 undergoing a forward flowforming operation. During this operation, the workpiece 118 may be placed over the mandrel 112 with its closed or semi-closed end toward the end of the mandrel 112 (to the right side of the mandrel, as shown in FIG. 7). The workpiece 118 may be secured against the end of the mandrel 118 by the tailstock 114, e.g., by means of a hydraulic force from the tailstock 114. The mandrel 112 and the workpiece 118 may then rotate about an axis 120 while the rollers 116 are moved into a position of contact with the outer surface of the workpiece 118 at a desired location along its length. The headstock 134 rotates or drives the mandrel 112 and the tailstock 114 provides additional support to rotate the mandrel 112, so that the long mandrel 112 spins properly.

The carriage 119 may then move the rollers 116 along the workpiece 118 (traveling from right to left, as shown in FIG. 7), generally in the direction indicated at 124. The rollers 116 may apply one or more forces to the outside surface of the workpiece 118 to reduce its wall thickness 126 and its outer diameter, e.g., using a combination of controlled radial, axial, and tangential forces. One or two jets 136 may be used to spray coolant on the rollers 116, the workpiece 118, and the mandrel 112, although more jets may be used to dissipate the adiabatic heat generated when the workpiece 118, initially at room temperature, for example, undergoes large amounts of plastic deformation. The mandrel 112 may even be submersed in coolant (not shown), e.g., in a trough type device, so that the coolant collects and pools on the mandrel 112 to keep the workpiece 118 cool.

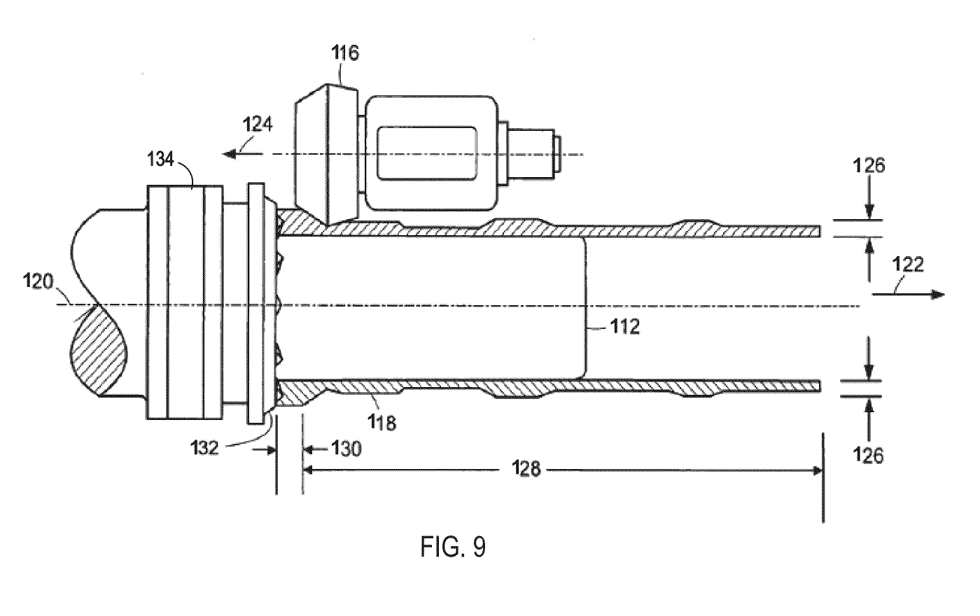

The rollers 116 may compress the outer surface of the workpiece 118 with enough force that the material is plastically deformed and moves or flows in the direction indicated at 122, generally parallel to the longitudinal axis 120. The rollers 116 may be positioned at any desired distance from the outer diameter of the mandrel 112, or the inner wall of the workpiece 118, to produce a wall thickness 126 that may be constant along the length of the workpiece 118, or varied, as shown in FIGS. 8 and 9. The length 128 represents the portion of the workpiece 118 that has undergone the flowforming operation, whereas the length 130 is the portion that has yet to be deformed. The operation shown in FIG. 8 is termed “forward flowforming” because the deformed material flows in the same direction 122 as the direction 124 that the rollers are moving.

In reverse flowforming, a flowforming device may be configured in a similar manner to that shown in FIG. 7, but a drive ring 132, rather than the tailstock 114, secures the workpiece 118 to the mandrel 112. As shown in FIGS. 7 and 9, the drive ring 132 is located near the headstock 134 at the non-free end of the mandrel 112. FIG. 9 shows a side-view of a workpiece 118 undergoing a reverse flowforming operation. During this operation, the workpiece 118 may be placed on the mandrel 112 and pushed all the way against the drive ring 132 at the non-free end of the mandrel 112 (to the left side, as shown in FIG. 9). The rollers 116 may be moved into a position of contact with the outer surface of the workpiece 118 at a desired location along its length. The carriage 119 may then move towards the drive ring 132 (in a right to left direction, as shown in FIG. 7) applying a force to the workpiece 118.

The force applied by the rollers 116 may push the workpiece 118 into the drive ring 132 where it may be entrapped or secured by a series of serrations or other securing features on the face of the drive ring 132. This allows the mandrel 112 and the workpiece 118 to rotate about the longitudinal axis 120 while the rollers 116 may apply one or more forces to the outer surface of the workpiece 118. The workpiece material is plastically deformed and moves or flows in direction 122 generally parallel to the axis 120. Similar to forward flowforming, the rollers 116 may be positioned at any desired distance from the outer diameter of the mandrel 112, or the inner wall of the workpiece 118, to produce a wall thickness 126 that may be constant or varied along the length of the workpiece 118. The length 128 represents the portion of the workpiece 118 that has undergone the flowforming operation, whereas the length 130 represents the portion that has yet to be deformed. As the workpiece 118 is deformed, it extends down the length of the mandrel 112 away from the drive ring 132. This operation is termed “reverse flowforming” because the deformed material flows in the direction 122 opposite to the direction 124 that the rollers are moving.

In addition to flowforming parts over a smooth mandrel to create a smooth inner diameter of the flowformed tube, splines, rifling, or other texturing may be formed into the bore of a flowformed tube. This may be accomplished by using a mandrel with surface texturing such as rifling, grooves, notches, or other configurations, which impress into the inner surface of the workpiece as it is flowformed. For example, the mandrel may be constructed with spiral, straight, periodic, or other desired ridges on its surface. These ridges leave the rifling, grooves, notches, and/or other configurations in the inner surface of the workpiece after the final flowforming pass is completed.

When the workpiece material is plastically deformed and compressed onto the mandrel under the set of rotating rollers, large wall thickness reductions may be realized in a single pass. With cylindrical alloy preforms, if less than a 20% wall thickness reduction is used per flowforming pass, the outermost part of the workpiece may be plastically deformed, but the material closest to the inner mandrel may not experience sufficient plastic deformation. If too large wall thickness reductions are performed in a single pass (e.g., greater than 75%), the workpiece may not be acceptably processed because the flowforming operation may not be able to plastically deform and move all of the material at one time. In some embodiments, an amount of wall thickness reduction may be performed on a first pass with smaller reductions performed on a second or subsequent passes, if necessary. Generally, when at least a 20% wall thickness reduction is performed in a flowforming operation, the material through the entire wall thickness plastically deforms sufficiently enough to uniformly elongate a preform into a flowformed tube. As used herein, the term “wall thickness reduction” means the percentage reduction in the annular-shaped cross-sectional area of a preform wall during a flowforming operation (i.e., reduction of area).

The flowforming process homogenously “refines” the grain size of the deformed material, and realigns the microstructure, relatively uniformly, in the longitudinal direction, substantially parallel to the center line of the flowformed tube. The flowforming process may be conducted in one or more flowforming passes. When two or more passes are used, the wall thickness reduction achieved in the first pass may be larger than in the subsequent passes, and may be at least a 25% wall thickness reduction. For example, for a 35% total wall thickness reduction using more than one pass, a first pass may be at least a 25% wall thickness reduction and a second pass may be a 10% wall thickness reduction. In another example, for a 50% total thickness wall reduction using more than one pass, a first pass may be at least a 25% wall thickness reduction, a second pass may be a 15% wall thickness reduction, and a third pass may be a 10% wall thickness reduction.

With the degree of cold work imparted by a flowforming operation, the hardness and tensile strength of a material are increased, while the ductility and impact toughness values are decreased. Cold working via flowforming also usually decreases the grain size of the flowformed material. Generally, when a material is cold worked, microscopic defects are nucleated throughout the deformed area. As defects accumulate through deformation, it becomes increasingly more difficult for slip, or the movement of defects, to occur. This results in a hardening of the material. If a material is subjected to too much cold work, the hardened material may fracture. Thus, with each flowforming pass, the deformed material becomes harder and less ductile, so a series of smaller and smaller reductions may be used after a first pass.

In addition to an increase in the biaxial strength and hardness of flowformed material, embodiments may also provide compressive residual stresses in the near surface material at the inner diameter of a flowformed component, induced by an autofrettage process. Autofrettage refers to metal fabrication techniques used on tubular components to provide increased strength and fatigue life to the tube by creating a compressive residual stress at the bore. In a typical autofrettage process, a pressure is applied within a tube bore resulting in plastic deformation of the near inner surface material, while the near outer surface material undergoes elastic deformation. As a result, after the pressure is removed, there is a distribution of residual stress, providing a residual compressive stress on the inner surface of the tube.

In various embodiments, in a final flowforming pass, the rollers may be configured to compress the outer diameter of the workpiece using a combination of axial and radial forces that causes the material at the inner diameter of the workpiece to be compressed onto the mandrel 112 with sufficient force so that the material at the inner diameter plastically deforms, thereby imparting a compressive stress to the inner diameter in an autofrettage-like manner. This may be accomplished, for example, by pulling the rollers sufficiently apart from one another. The flowforming operation then causes the workpiece to compress against and grip the mandrel, instead of the workpiece just releasing from or springing back off of the mandrel, which is what typically occurs during a standard flowforming operation. Compressing the inner diameter against the mandrel in this manner imparts a compressive hoop stress on the inner diameter of the flowformed component.

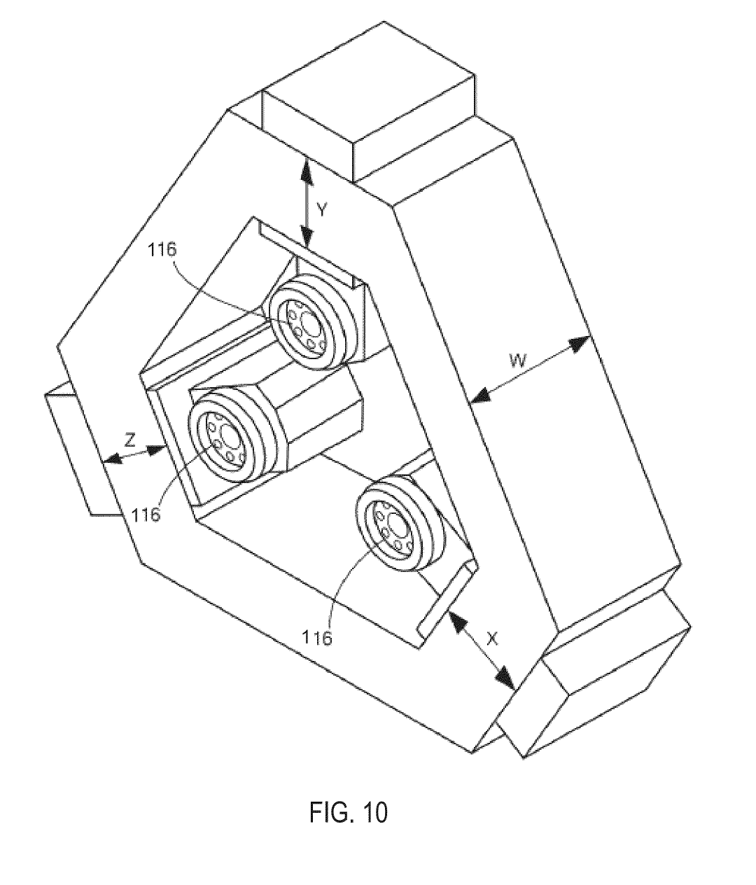

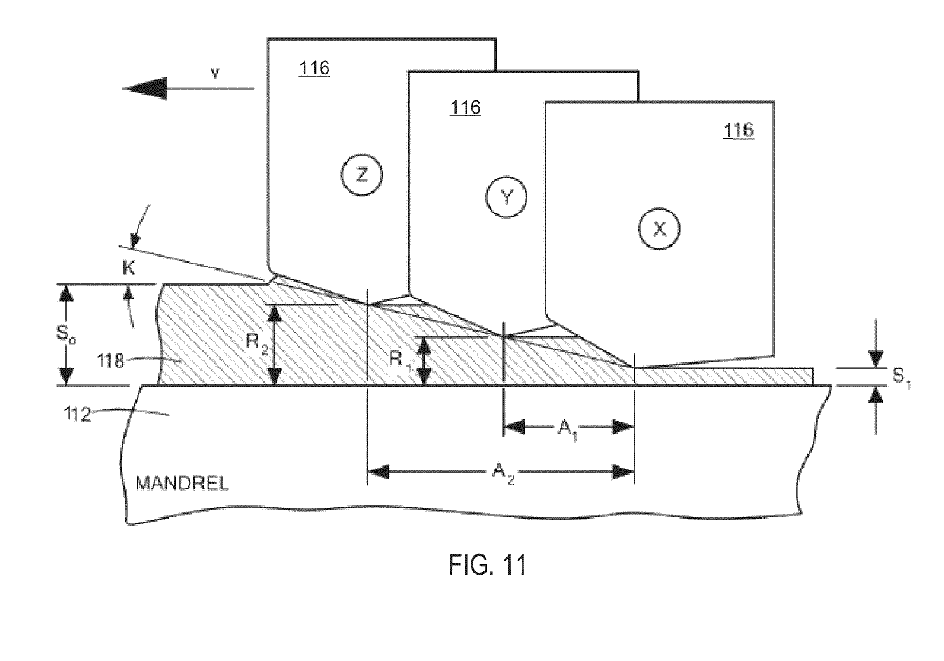

FIGS. 10 and 11 show a schematic perspective view and schematic side view, respectively, of a three-roller flowforming configuration. FIG. 10 shows a carriage that houses three flowforming rollers 116 (shown as X, Y, and Z in FIG. 11) that may move along three axes (shown as the X-, Y-, and Z-axes in FIG. 10), and which are radially located around a spindle axis, e.g., at 120° apart from one another. Although the figures show three rollers, a flowforming operation may use two or more rollers. For example, a four roller configuration may be used in embodiments where large deformation forces may be necessary and the load can be distributed over more rollers. The independently programmable X, Y, and Z rollers provide the necessary radial forces, while the right to left programmable feed motion of the W-axis applies the axial force. Each of the rollers may have a specific geometry to support its particular role in the flowforming operation.

The position of the rollers 116 may be longitudinally and/or radially staggered with respect to one another. The amount of stagger may be varied and may be based on the initial wall thickness of the workpiece and the amount of wall reduction desired in a given flowforming pass. For example, as shown in FIG. 11, Sₒ represents the wall thickness of a workpiece before a flowforming pass and S₁ represents the workpiece wall thickness after the flowforming operation with the rollers 116 moving in the v direction. The rollers 116 may be staggered longitudinally along a longitudinal direction of the workpiece 118 (shown as the W-axis in FIG. 10), and may be staggered radially with respect to the centerline or inner diameter of the workpiece (along the X-, Y- and Z-axes), to apply a relatively uniform compression to the outside of the workpiece 118. For example, as shown in FIG. 11, roller X may be separated from roller Y by a displacement or distance A₁, and roller X may be separated from roller Z by a distance A₂, along a longitudinal direction of the workpiece 118. Similarly, roller X may be radially displaced from the inner diameter of the workpiece a distance, S₁, which is the desired wall thickness of the workpiece 118 after a flowforming pass, roller Y may be radially displaced a distance R₁, and roller Z may be radially displaced a distance R₂, from the inner diameter of the workpiece. As shown, an angle K may be used to determine the amount of radial staggering once an axial staggering pattern has been established.

The more the rollers X, Y, and Z are separated from one another the greater the helical twist imparted to the grain structure of the workpiece material. The compressive hoop stress imparted to the component in this manner (autofrettage) may reduce the probability of crack initiation and decrease the growth rate of any crack that may initiate on the inner diameter of the component, effectively improving the fatigue life of a flowformed tube. Another benefit of flowforming is that the amount of compressive stress imparted to the inner diameter may be varied along the length of the tube depending on the roller configuration. For example, the rollers may be configured in such a way that a compressive stress is only imparted to one portion of the tube, e.g., on one end or in the middle of the tube.

In a flowforming operation, a lubricant may be used between the inner diameter of the workpiece and the mandrel in order to reduce the likelihood of the workpiece sticking or jamming onto the mandrel.

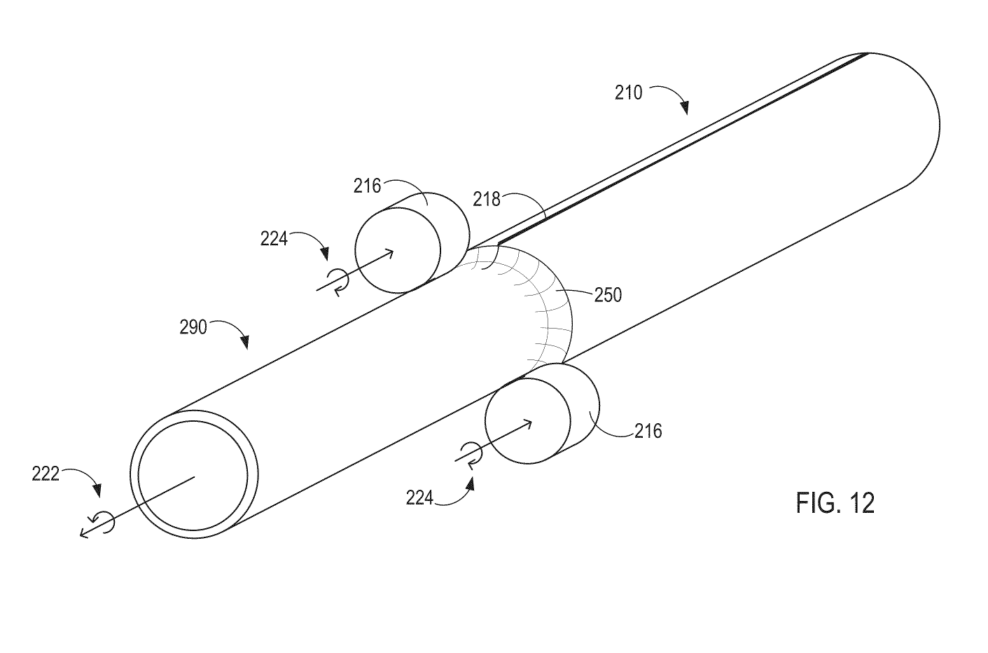

The closed-seam (welded) hollow cylindrical preform is flowformed to decrease the outside diameter, increase the length, and remove the welded seam, thereby providing a seamless cold worked (cold hardened) alloy tube. FIG. 12 schematically illustrates the reverse flowforming of a closed-seam (welded) hollow cylindrical preform 210 comprising a welded seam 218. The preform 210 is placed on a mandrel (not shown) and secured against a drive ring (not shown). The drive ring rotates the preform 210 in a rotation direction as indicated by the rotational arrow at 222. The rollers 216 of the flowforming apparatus rotate and move in a longitudinal direction as indicated by the arrows at 224, engaging and plastically deforming the preform 210 (although two rollers 216 are shown, a third roller may be present and obscured in the view by the flowformed tube 290). The plastically deformed alloy material of the preform 210 emerges on the opposite side of the rollers as flowformed tube 290 and flows in the longitudinal direction indicated by the linear arrow at 222. A transitional region 250 between the preform 210 and tube 290 occurs where the rollers 216 axially engage the workpiece in the longitudinal direction. As shown in FIG. 12, the flowformed tube 290 produced from the closed-seam (welded) hollow cylindrical preform 210 lacks an observable weld seam and, therefore, is a welded and seamless tube.

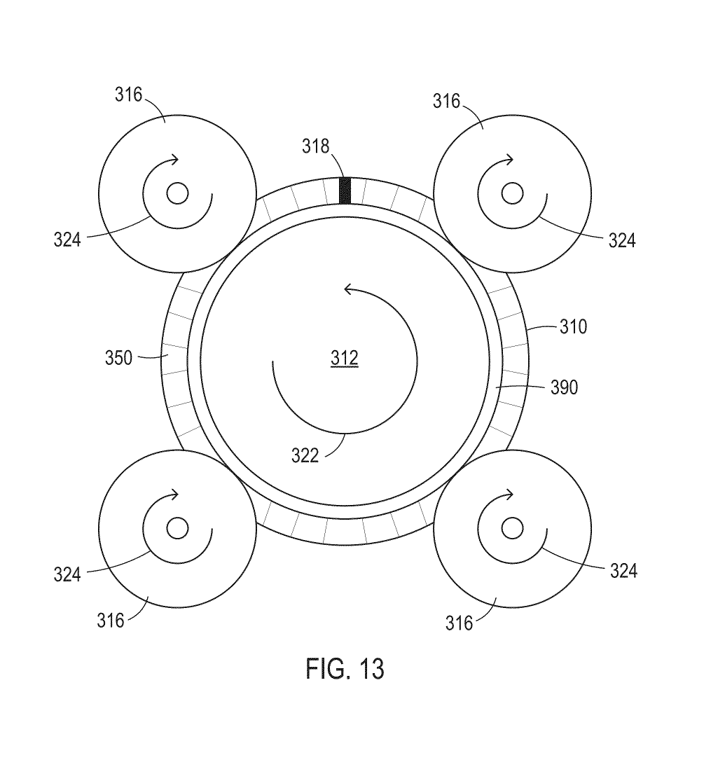

FIG. 13 schematically illustrates the reverse flowforming of a closed-seam (welded) hollow cylindrical preform 310 comprising a welded seam 318. The preform 310 is placed on a mandrel 312 and secured against a drive ring (not shown). The drive ring rotates the preform 310 in a rotation direction as indicated by the rotational arrow at 322. The rollers 316 of the flowforming apparatus rotate and move in a longitudinal direction into the plane of the page, engaging and plastically deforming the preform 310. A four-roller configuration is shown in FIG. 13. As noted above, a four roller configuration may be used in embodiments where large deformation forces may be necessary and the load can be distributed over more rollers.

The plastically deformed alloy material of the preform 310 emerges on the opposite side of the rollers as flowformed tube 390 and flows in the longitudinal direction out of the plane of the page. A transitional region 350 between the preform 310 and tube 390 occurs where the rollers 316 axially engage the workpiece in the longitudinal direction. As shown in FIG. 13, the flowformed tube 390 produced from the closed-seam (welded) hollow cylindrical preform 310 lacks an observable weld seam and, therefore, is a welded and seamless tube.

The flowforming of closed-seam (welded) hollow cylindrical preforms, including but not necessarily limited to expanded and/or annealed preforms, may produce seamless tubes in a cold worked (cold hardened) condition. For instance, the flowforming operations to deform preforms into tubes may be performed at room temperature and/or with chilled coolant to ensure that the deformation occurs at a cold working temperature. The flowforming operations to deform preforms into tubes may cold work the alloy material to a reduction-of-area in the range of 20% to 80%, inclusive, or any sub-range subsumed therein, such as, for example, 25% to 75%, 50% to 75%, 50% to 70%, 25% to 65%, 30% to 65%, 30% to 60%, greater than 30% to less than 60%, 35% to 55%, or 40% to 50%. The flowforming operations to deform preforms into tubes may be performed in a single pass or multiple passes.

Flowforming the preforms to produce tubes provides for the ability to control the precise level of cold work (quantified as reduction-of-area) necessary to achieve predetermined target material properties in the tubes. For instance, flowforming allows for precise control over the reduction-of-area (e.g., in the range of 30% to 60%, depending on the specific alloy) required to achieve a predetermined balance of room temperature yield strength, ultimate tensile strength, elongation, and hardness in tubes in a cold worked (cold hardened) condition. This provides for the ability to effectively and efficiently produce tubes that comply with the chemical composition, dimensional, mechanical, and microstructural requirements of the ANSI/API Specification 5CRA.

The flowforming operations to deform preforms into tubes may provide tubes in a cold worked (cold hardened) condition having room temperature properties including a yield strength of at least 110 ksi (758 MPa), an ultimate tensile strength of at least 125 ksi (862 MPa), an elongation of at least 9%, and/or an HRC hardness number no greater than 38. As used herein, the term “yield strength” refers to the 0.2% offset yield point. The tubes produced by the processes described in this specification may be characterized by a yield strength of at least 110 ksi (758 MPa) and no greater than 160 ksi (1,103 MPa). The tubes produced by the processes described in this specification may have ultimate tensile strengths that are at least 10 ksi (70 MPa) greater than the yield strength of the tubes. The tubes produced by the processes described in this specification may have a yield strength of at least 125 ksi (862 MPa), an ultimate tensile strength of at least 130 ksi (896 MPa), an elongation of at least 10%, and/or an HRC hardness number no greater than 37. The tubes produced by the processes described in this specification may have a yield strength of at least 140 ksi (965 MPa) and/or an ultimate tensile strength of at least 145 ksi (1000 MPa). The tubes produced by the processes described in this specification may have an elongation of at least 12% and/or an HRC hardness number no greater than 36.

The flowforming operations to deform preforms into tubes may provide tubes having an outside diameter of at least 1.0 inches (25.4 mm) and a wall thickness of at least 0.015 inches (0.381 mm). The flowforming operations to deform preforms into tubes may provide tubes having an outside diameter of at least 1.5 inches (81.1 mm) and a wall thickness of at least 0.020 inches (0.508 mm). The flowforming operations to deform preforms into tubes may provide tubes having an outside diameter of at least 2.0 inches (50.8 mm) and a wall thickness of at least 0.025 inches (0.635 mm).

The flowforming operations to deform preforms into tubes may provide tubes having an outside diameter of at least 6.5 inches (165.1 mm), a wall thickness of at least 0.231 inches (5.87 mm), and/or a length of at least 28.0 feet (8.5 meters). The flowforming operations to deform preforms into tubes may provide tubes having an outside diameter of at least 7.0 inches (177.8 mm), a wall thickness of at least 0.231 inches (5.87 mm), and/or a length of at least 34.0 feet (10.4 meters). The flowforming operations to deform preforms into tubes may provide tubes having an outside diameter of at least 9.625 inches (244.5 mm), wall thickness of at least 0.312 inches (7.92 mm), and/or a length of at least 36.0 feet (11.0 meters). The flowforming operations to deform preforms into tubes may provide tubes having an outside diameter of at least 9.875 inches (250.8 mm), a wall thickness of at least 0.625 inches (15.9 mm), and/or a length of at least 36.0 feet (11.0 meters).

After the flowforming operation, the tubes may optionally be annealed. A suitable annealing temperature may be selected based on the identity of the alloy material of the flowformed tube. For example, duplex stainless steel tubes may be annealed at a temperature in the range of 875° C. to 1200° C. (1607-2192° F.), or any sub-range subsumed therein, such as, for example, 1010° C.-1177° C. (1850-2150° F.), 982° C. to 1149° C. (1800-2100° F.), 950° C. to 1150° C. (1742-2102° F.), or 1000° C. to 1100° C. (1832-2012° C.). Super duplex and hyper duplex stainless steel tubes, for example, may be annealed at a temperature in the range of 950° C. to 1200° C. (1742-2192° F.), or any sub-range subsumed therein, such as, for example, 1010° C.-1177° C. (1850-2150° F.), 982° C. to 1149° C. (1800-2100° F.), 1050° C. to 1150° C. (1922-2102° F.), or 1075° C. to 1100° C. (1967-2012° F.). Generally, for duplex, super duplex, and hyper duplex stainless steels, annealing at suitable higher temperatures tends to increase the ferrite content compared with annealing at suitable lower temperatures.

Annealing treatments may be performed at temperatures above the recrystallization temperature of the alloy of the flowformed tube. Annealing treatments may recrystallize the cold worked microstructure of the flowformed tube. Annealing treatments may be performed by heating the tube to a surface temperature in an annealing temperature range and then maintaining the tube for a predetermined time-at-temperature before cooling the tube (e.g., by removing the preform from an annealing furnace). For example, a tube may be heated to a specified surface temperature in an annealing temperature range and then maintained at temperature for at least 5 minutes, at least 10 minutes, at least 15 minutes, at least 20 minutes, at least 25 minutes, or at least 30 minutes (time-at-temperature). Alternatively, annealing treatments may be performed by placing the tube in an annealing furnace (or other controlled temperature environment) operating at temperature and then maintaining the tube in the furnace for a predetermined furnace time before cooling the tube (e.g., by removing the tube from the annealing furnace). For example, a tube may be placed into an annealing furnace operating at a specified temperature in an annealing temperature range and then maintained in the furnace for at least 5 minutes, at least 10 minutes, at least 15 minutes, at least 20 minutes, at least 25 minutes, or at least 30 minutes (furnace time). A tube may be maintained at temperature or in an operating furnace for a period of time not to exceed, for example, 60 minutes, 45 minutes, 30 minutes, or 15 minutes (time-at-temperature or furnace time, as the case may be).

In embodiments comprising an optional annealing operation, the annealed tube may be quenched from annealing temperatures after a specified time-at-temperature or furnace time. For example, a tube may be quenched from an annealing temperature after no more than 30 minutes, no more than 25 minutes, no more than 20 minutes, or no more than 15 minutes (time-at-temperature or furnace time, as the case may be). Quenching may be performed at a cooling rate that prevents the precipitation of deleterious phases during the cooling. Such cooling rates may be achieved, for example, using a water quenching operation.

The processes described in this specification may be used to form seamless alloy tubes from alloy plates comprising, for example, CRAs including, but not limited to, martensitic stainless steels, martensitic/ferritic stainless steels, austenitic stainless steels, duplex (austenitic/ferritic) stainless steels, super duplex (austenitic/ferritic) stainless steels, hyper duplex (austenitic/ferritic) stainless steels, austenitic nickel base alloys, austenitic nickel base superalloys, and titanium base alloys.

For example, a stainless steel plate comprising a duplex, super duplex, or hyper duplex stainless steel may be used to produce a stainless steel tube in accordance with the processes described in this specification. Duplex stainless steels have a mixed microstructure of austenite and ferrite. The distinction between duplex, super duplex, and hyper duplex is generally made based on pitting resistance equivalent number (PREN=% Cr+3.3*(% Mo+0.5*% W)+16*% N), wherein duplex stainless steels have a PREN of at least 35, super duplex stainless steels have a PREN of at least 40, and hyper duplex stainless steels have a PREN of at least 45. Examples of duplex, super duplex, and hyper duplex stainless steels that are suitable for the production of tubes in accordance with the processes described in this specification include, but are not limited to, the stainless steels respectively listed in Tables 2-4 (compositions specified in mass percentages based on total alloy mass).

TABLE 2
Duplex Stainless Steels

| UNS No. | Cr | Ni | Mo | N | Mn | C | Cu | W | Fe |
|---|---|---|---|---|---|---|---|---|---|
| S32304 | 21.5-24.5 | 3.0-5.5 | 0.05-0.60 | 0.05-0.20 | ≦2.50 | ≦0.03 | 0.05-0.60 | — | bal. |
| S32003 | 19.5-22.5 | 3.0-4.0 | 1.5-2.0 | 0.14-0.20 | ≦2.00 | ≦0.03 | — | — | bal. |
| S31803 | 21.0-23.0 | 4.5-6.5 | 2.5-3.5 | 0.08-0.20 | ≦2.00 | ≦0.03 | — | — | bal. |
| S32205 | 22.0-23.0 | 4.5-6.5 | 3.0-3.5 | 0.14-0.20 | ≦2.00 | ≦0.03 | — | — | bal. |
| S32550 | 24.0-27.0 | 4.5-6.5 | 2.9-3.9 | 0.10-0.25 | ≦1.50 | ≦0.04 | 1.5-2.5 | — | bal. |

TABLE 3
Super Duplex Stainless Steels

| UNS No. | Cr | Ni | Mo | N | Mn | C | Cu | W | Fe |
|---|---|---|---|---|---|---|---|---|---|
| S32750 | 24.0-26.0 | 6.0-8.0 | 3.0-5.0 | 0.24-0.32 | ≦1.20 | ≦0.04 | ≦0.5 | — | bal. |
| S32760 | 24.0-26.0 | 6.0-8.0 | 3.0-4.0 | 0.20-0.30 | ≦1.00 | ≦0.04 | 0.5-1.0 | 0.5-1.0 | bal. |
| S32808 | 27.0-27.9 | 7.0-8.2 | 0.8-1.2 | 0.30-0.40 | ≦1.10 | ≦0.03 | — | 2.1-2.5 | bal. |
| S32906 | 28.0-30.0 | 5.8-7.5 | 1.5-2.6 | 0.30-0.40 | 0.80-1.5 | ≦0.03 | ≦0.8 | — | bal. |
| S32950 | 26.0-29.0 | 3.5-5.2 | 1.0-2.5 | 0.15-0.35 | ≦2.00 | ≦0.03 | — | — | bal. |
| S39274 | 24.0-26.0 | 6.8-8.0 | 2.5-3.5 | 0.24-0.32 | ≦1.0 | ≦0.03 | 0.2-0.8 | 1.5-2.5 | bal. |
| S39277 | 24.0-26.0 | 6.5-8.0 | 3.0-4.0 | 0.23-0.33 | ≦0.80 | ≦0.025 | 1.2-2.0 | 0.8-1.2 | bal. |

TABLE 4
Hyper Duplex Stainless Steels

| UNS No. | Cr | Ni | Mo | N | Mn | C | Cu | Fe |
|---|---|---|---|---|---|---|---|---|
| S32707 | 26.0-29.0 | 5.5-9.5 | 4.0-5.0 | 0.30-0.50 | ≦1.5 | ≦0.03 | ≦1.0 | bal. |
| S33207 | 29.0-33.0 | 6.0-9.0 | 3.0-5.0 | 0.40-0.60 | ≦1.5 | ≦0.03 | ≦1.0 | bal. |

The stainless steels listed in Tables 2-4 above may comprise the constituent elements, consist essentially of the constituent elements, or consist of the constituent elements, and incidental impurities.

For example, the processes described in this specification may produce a stainless steel tube comprising a super duplex stainless steel comprising (in mass percent):

24.0-26.0% chromium;

6.0-8.0% nickel;

3.0-5.0% molybdenum;

0.20-0.32% nitrogen;

up to 0.04% carbon;

optionally, 0.5-1.0% copper;

optionally, 0.5-1.0% tungsten; and

iron and incidental impurities.

In various embodiments, the processes described in this specification may produce a duplex stainless steel tube having a volume fraction of ferrite ranging from 40% to 60%. In various embodiments, the processes described in this specification may produce a super duplex stainless steel tube having a volume fraction of ferrite ranging from 35% to 55%.

Other examples of CRAs that may be suitable for the production of tubes in accordance with the processes described in this specification include, but are not limited to, Alloy 2205 (UNS S31803) duplex stainless steel, Alloy 2507 super duplex stainless steel (UNS S32750, S32760, S39274), Alloy 028 (UNS N08028) Ni—Cr—Fe austenitic stainless steel, Alloy 825 (UNS N08825) Ni—Fe—Cr alloy, Alloy G-3 (UNS N06985) Ni—Cr—Fe alloy, Alloy 050 (UNS N06950) nickel base alloy, Alloy C-276 (UNS N10276) nickel base alloy, Alloy 600 (UNS N06600) nickel base alloy, Alloy 617 (UNS N06617) nickel base alloy, Alloy 625 (UNS N06625) nickel base alloy, Alloy 690 (UNS N06690) nickel base alloy, Alloy 718 (UNS N07718) nickel base alloy, Ti-15V-3Cr-3Sn-3Al alloy (UNS R58153), Ti-4Al-2.5V-1.5Fe-0.250 alloy (UNS R54250), Ti-3Al-2.5V alloy (UNS R56320), Ti-3Al-8V-6Cr-4Mo-4Zr alloy (UNS R58640), Ti-4.5Al-3V-2Mo-2Fe alloy (SP-700; UNS: None), and commercially pure titanium (UNS R50250, R50400, R50550, R50700; ASTM Grades 1-4).

The chemical composition of certain nickel base alloys and titanium base alloys that are suitable for the production of tubes in accordance with the processes described in this specification are listed in Tables 5 and 6 below (compositions specified in mass percentages based on total alloy mass, and may comprise the constituent elements, consist essentially of the constituent elements, or consist of the constituent elements, and incidental impurities).

TABLE 5
Nickel Base Alloys

| | UNS No. | | | | |
|---|---|---|---|---|---|
| Element | N06600 | N06617 | N06625 | N06690 | N07718 |
| Cr | 14.0-17.0 | 20.0-24.0 | 20.0-23.0 | 27.0-31.0 | 17.00-21.00 |
| Co | — | 10.0-15.0 | ≦1.0 | — | ≦1.00 |
| Mo | — | 8.0-10.0 | 8.0-10.0 | — | 2.80-3.30 |
| Al | — | 0.8-1.5 | ≦0.40 | — | 0.20-0.80 |
| Fe | 6.00-10.00 | ≦3.0 | ≦5.0 | 7.0-11.0 | balance |
| C | ≦0.15 | 0.05-0.15 | ≦0.10 | ≦0.05 | ≦0.08 |
| Mn | ≦1.00 | ≦1.0 | ≦0.50 | ≦0.50 | ≦0.35 |
| S | ≦0.015 | ≦0.015 | ≦0.015 | ≦0.015 | ≦0.015 |
| Si | ≦0.50 | ≦1.0 | ≦0.50 | ≦0.50 | ≦0.35 |
| Cu | ≦0.50 | ≦0.5 | — | ≦0.50 | ≦0.30 |
| Ti | — | ≦0.6 | ≦0.40 | — | 0.65-1.15 |
| B | — | ≦0.006 | — | — | ≦0.006 |
| Nb + | — | — | 3.15-4.15 | — | 4.75-5.50 |
| Ta | | | | | |
| P | — | — | ≦0.015 | — | ≦0.015 |
| Ni | balance | balance | balance | balance | 50.00-55.00 |
| | (≧72.0) | (≧44.5) | (≧58.0) | (≧58.0) | |

TABLE 6
Titanium Base Alloys

| | UNS No. | | | | |
|---|---|---|---|---|---|
| Element | R58153 | R54250 | R56320 | R58640 | None (SP-700) |
| Al | 2.5-3.5 | 3.5-4.5 | 2.5-3.5 | 3.0-4.0 | 4.0-5.0 |
| V | 14.0-16.0 | 2.0-3.0 | 2.0-3.0 | 7.5-8.5 | 2.5-3.5 |
| Fe | ≦0.25 | 1.2-1.8 | ≦0.20 | ≦0.30 | 1.7-2.3 |
| O | ≦0.13 | 0.20-0.30 | ≦0.15 | ≦0.12 | ≦0.15 |
| Cr | 2.5-3.5 | — | — | 5.5-6.5 | — |
| Sn | 2.5-3.5 | — | — | — | — |
| Mo | — | — | — | 3.5-4.5 | 1.8-2.2 |
| Zr | — | — | — | 3.5-4.5 | — |
| C | ≦0.05 | ≦0.08 | ≦0.050 | ≦0.05 | ≦0.08 |
| N | ≦0.05 | ≦0.03 | ≦0.030 | ≦0.03 | ≦0.05 |
| H | ≦0.015 | ≦0.015 | ≦0.015 | ≦0.030 | ≦0.01 |
| Ti | balance | balance | balance | balance | balance |

The processes described in this specification may produce tubes that comply with the ANSI/API Specification 5CRA, first edition, February 2010. The processes described in this specification provide for precise control over the chemical composition, dimensions, mechanical properties, and microstructure of the produced tubes. The ANSI/API Specification 5CRA establishes requirements for these properties, among others, for OCTGs. Accordingly, the processes described in this specification are useful for the production of standard-compliant OCTGs.

The ANSI/API Specification 5CRA establishes standard length ranges for OCTGs: Range 1 (16.0-25.0 feet; 4.88-7.62 meters); Range 2 (25.0-34.0 feet; 7.62-10.36 meters); and Range 3 (34.0-48.0 feet; 10.36-14.63 meters). The ANSI/API Specification 5CRA also establishes standard outside diameters (OD) and wall thicknesses (WT) for OCTGs ranging from 1.050-13.375 inches (26.67-339.72 mm) OD and 0.113-0.797 inch (2.87-20.24 mm) WT. Prior tube production processes are not capable of economically producing tubes on a commercial scale that fall within the upper ends of these dimensional ranges and also meet the mechanical property requirements set by the ANSI/API Specification 5CRA (for example, minimum yield and tensile strengths, minimum elongations, and maximum hardness levels). The processes described in this specification may allow for the efficient production of longer (e.g., Range 3) and larger outside diameter (e.g., greater than 7 inches/177.8 mm) and larger wall thickness (e.g., greater than 0.5 inch/12.7 mm) seamless CRA tubes in a cold worked (cold hardened) condition that may meet the mechanical property requirements set by the ANSI/API Specification 5CRA.

Although various embodiments of the processes described in this specification have been described in connection with OCTGs, it is to be understood that the production processes and produced tubes are not limited to oil and gas applications. For example, the tubes produced by the processes described in this specification may be suitable for any application in which high strength and toughness and corrosion/erosion resistance are important, such as, for example, chemical processing, petrochemical processing, power generation, mining, waste treatment, and aerospace/aircraft applications.

### EXAMPLES

### Example 1

A plate of Alloy 625 (UNS N06625; 20.0%-23.0% chromium, 8.0%-10.0% molybdenum, 3.15%-4.15% niobium and/or tantalum, up to 5.0% iron, up to 1.0% cobalt, up to 0.50% manganese, up to 0.5% silicon, up to 0.4% titanium, up to 0.4% aluminum, up to 0.10% carbon, balance nickel and incidental impurities (mass percentage)) was machined to improve the flatness of the plate. The machined plate had dimensions of approximately 8 inches (203.2 mm) width and 0.750 inch (19.05 mm) thickness. The plate was roll bent into a cylindrical hollow preform having a longitudinal seam region located between two abutting ends of the deformed plate. The roll bent plate was laser welded in a nitrogen gas atmosphere, joining together the abutting ends. Weld kerf was removed from the laser welded longitudinal seam region.

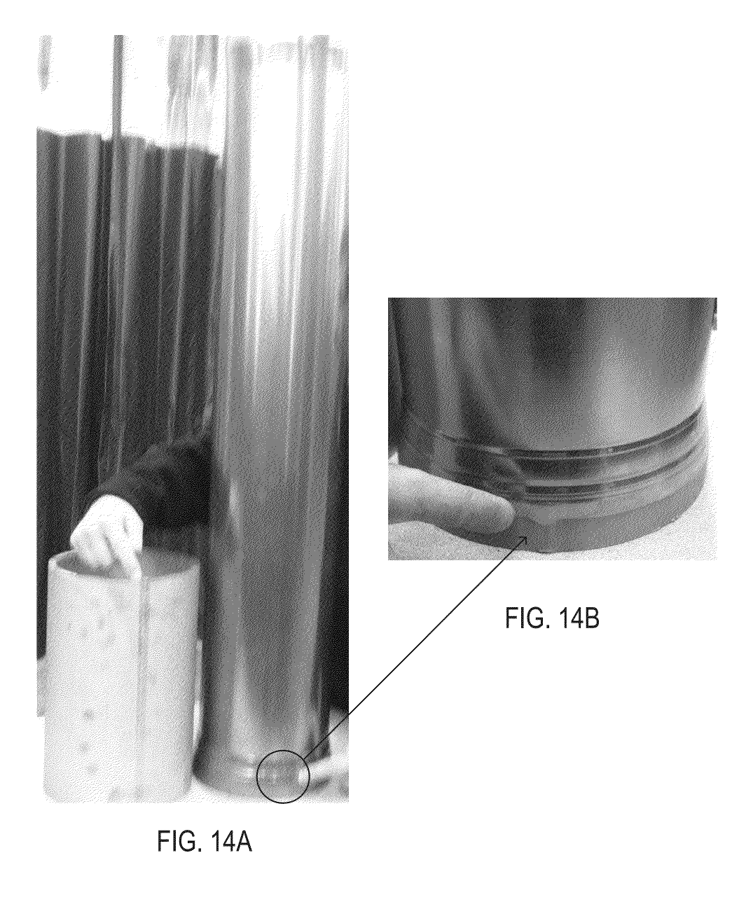

The closed-seam (welded) preform was reverse flowformed at ambient temperature to a reduction-of-area of approximately 50%. The process produced an Alloy 625 tube having an outside diameter of 8.625 inches (219.8 mm) and a wall thickness of 0.375 inch (9.53 mm). FIG. 14A shows the flowformed Alloy 625 tube (right side) and a rolled-and-welded Alloy 625 preform (left side) similar to the preform that was flowformed into the tube. As shown in FIG. 14A, the laser weld seam was clearly visible in the preform, but was not visible in the flowformed tube. FIG. 14B shows the remaining laser weld seam on the driven end of the flowformed tube that engaged the drive ring in the flowforming apparatus.

### Example 2

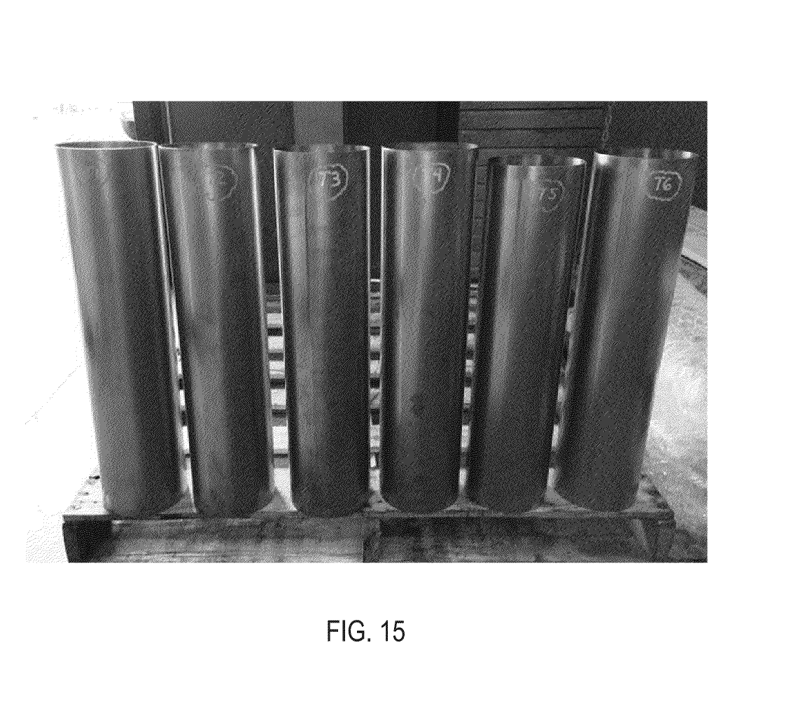

Plates of Ti-15V-3Cr-3Sn-3Al alloy (UNS R58153; 14.0%-16.0% vanadium, 2.5%-3.5% chromium, 2.5%-3.5% tin, 2.5%-3.5% aluminum, balance titanium and incidental impurities (mass percentage)) were roll bent into cylindrical hollow preforms having longitudinal seam regions located between two abutting ends of the deformed plates. The plates had dimensions of approximately 22-23 inches (559-584 mm) length, 17 inches (432 mm) width, and 0.050 inches (1.27 mm) thickness. The roll bent plates were laser welded in a nitrogen gas atmosphere, joining together the abutting ends. Weld kerf was removed from the laser welded longitudinal seam regions. The closed-seam (welded) preforms had inside diameters of approximately 5.418 inches (138 mm), wall thicknesses of approximately 0.050 inches (1.27 mm), and lengths of approximately 22-23 inches (559-584 mm). The closed-seam (welded) preforms are shown in FIG. 15.

The closed-seam (welded) preforms were cut approximately in half into two sections and each section was reverse flowformed at ambient temperature. The flowformed samples were cold worked to reductions-of-area of approximately 51%, 53%, 57%, 61%, and 67% and produced Ti-15V-3Cr-3Sn-3Al alloy tubes having wall thickness of approximately 0.017 inches (0.43 mm), 0.020 inches (0.51 mm), 0.022 inches (0.56 mm), 0.024 inches (0.61 mm), and 0.025 inches (0.64 mm).

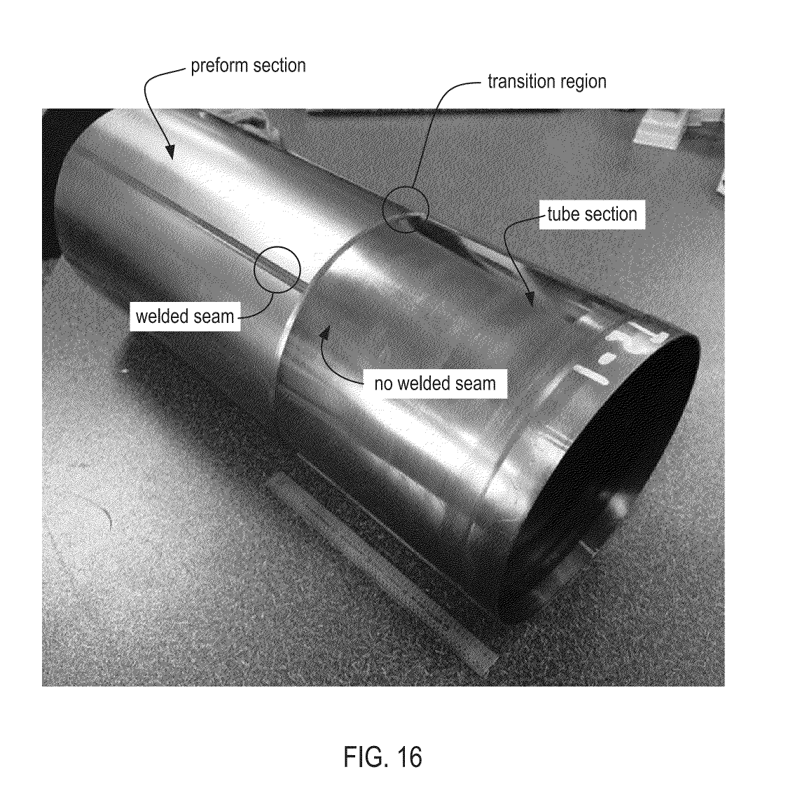

FIG. 16 shows one of the Ti-15V-3Cr-3Sn-3Al alloy samples in a partially flowformed condition (compare with the schematic diagram in FIG. 12). The partially flowformed sample includes the closed-seam (welded) preform section, the flowformed seamless tube section, and the transition region between the preform section and the tube section. The welded seam is visible in the preform section, but disappears in the transition region, and is not present in the seamless tube section.

### Example 3

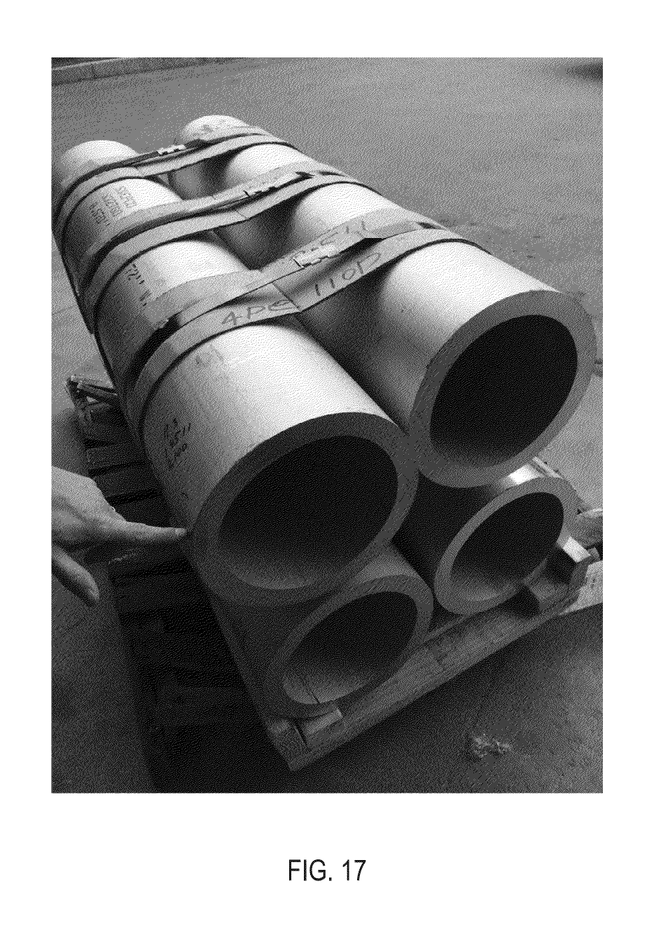

Plates of super duplex stainless steel (UNS S32760; 24.0%-26.0% chromium, 6.0%-8.0% nickel, 3.0%-4.0% molybdenum, 0.20%-0.30% nitrogen, up to 1.0% manganese, up to 0.04% carbon, 0.5%-1.0% copper, 0.5%-1.0% tungsten, and balance iron and incidental impurities (mass percent)) were roll bent into cylindrical hollow preforms having longitudinal seam regions located between two abutting ends of the deformed plates. The plates were approximately 1.20 inches (30.5 mm) thick. The roll bent plates were laser welded in a nitrogen gas atmosphere, joining together the abutting ends. Weld kerf was removed from the laser welded longitudinal seam regions. The closed-seam (welded) preforms had a wall thick of approximately 1.20 inches (30.5 mm). The closed-seam (welded) preforms are shown in FIG. 17.

The closed-seam (welded) preforms were reverse flowformed at ambient temperature. The flowformed samples were cold worked to reductions-of-area of approximately 75% and produced super duplex stainless steel tubes having wall thickness of approximately 0.30 inches (7.6 mm).

### Example 4

A plate of CRA is provided having dimensions of length 18.0 feet (5.5 meters), width 9.125 inches (231.8 mm), and thickness 1.2 inch (30.5 mm). The major top and bottom surfaces of the plate are ground or machined to ensure that the plate exhibits a flatness of at least ±0.020 inch (±0.508 mm). The opposed longitudinal ends (18.0 feet/5.5 meters) are machined to ensure that they are parallel and, if necessary, to provide an appropriate welding bevel.

The plate is roll bent into an open-seam hollow cylindrical preform having a longitudinal seam region located between the two abutting longitudinal ends of the deformed plate. The open-seam hollow cylindrical preform is welded to join together the abutting ends and close the seam. The welded hollow cylindrical preform has dimensions of length 18.0 feet (5.5 meters), inside diameter 9.25 inches (235.0 mm), and outside diameter 10.375 inches (263.5 mm).

The welded hollow cylindrical preform is reverse flowformed at room temperature to decrease the outside diameter to 9.875 inches (250.8 mm) and increase the length to 36 feet (11.0 meters) (about 50% reduction-of-area). The resulting CRA tube has dimensions of length 36 feet (11.0 meters), outside diameter 9.875 inches (250.8 mm), and wall thickness 0.625 inch (15.9 mm).

The CRA tube has a yield strength of at least 110 ksi (758 MPa) and no greater than 160 ksi (1,103 MPa), an ultimate tensile strength of at least 125 ksi (862 MPa), an elongation of at least 9%, and an HRC hardness number no greater than 38. The CRA tube complies with ANSI/API Specification 5CRA, first edition, February 2010.

### Example 5

A plate of Alloy 2507 super duplex stainless steel (UNS S32750; nominally 25.0% chromium, 7.0% nickel, 3.8% molybdenum, 0.27% nitrogen, balance iron and incidental impurities) is provided having dimensions of length 18.0 feet (5.5 meters), width 9.125 inches (231.8 mm), and thickness 1.2 inch (30.5 mm). The major top and bottom surfaces of the plate are ground or machined to ensure that the plate exhibits a flatness of at least ±0.020 inch (±0.508 mm). The opposed longitudinal ends (18.0 feet/5.5 meters) are machined to ensure that they are parallel and, if necessary, to provide an appropriate welding bevel.

The plate is roll bent into an open-seam hollow cylindrical preform having a longitudinal seam region located between the two abutting longitudinal ends of the deformed plate. The open-seam hollow cylindrical preform is laser welded to join together the abutting ends and close the seam. The laser welding is performed in a nitrogen gas atmosphere provided by nitrogen shield gas flowing from nozzles directed toward the longitudinal seam region during the weld passes. Weld kerf is burnished or skived from the laser welded longitudinal seam region. The closed-seam (welded) hollow cylindrical preform is radially expanded about 1% (based on inside diameter) in a tube expander to ensure that the preform is longitudinally straight and circumferentially round. The welded-and-expanded hollow cylindrical preform has dimensions of length 18.0 feet (5.5 meters), inside diameter 9.25 inches (235.0 mm), and outside diameter 10.375 inches (263.5 mm).

The welded-and-expanded hollow cylindrical preform is reverse flowformed at room temperature to decrease the outside diameter to 9.875 inches (250.8 mm) and increase the length to 36 feet (11.0 meters) (about 50% reduction-of-area). The resulting Alloy 2507 super duplex stainless steel tube has dimensions of length 36 feet (11.0 meters), outside diameter 9.875 inches (250.8 mm), and wall thickness 0.625 inch (15.9 mm).

The Alloy 2507 super duplex stainless steel tube has a yield strength of at least 110 ksi (758 MPa) and no greater than 160 ksi (1,103 MPa), an ultimate tensile strength of at least 125 ksi (862 MPa), an elongation of at least 9%, and an HRC hardness number no greater than 38. The Alloy 2507 super duplex stainless steel tube complies with ANSI/API Specification 5CRA, first edition, February 2010.

Various features and characteristics of the inventions are described in this specification to provide an overall understanding of the disclosed processes and products. It is understood that the various features and characteristics described in this specification can be combined in any suitable manner regardless of whether such features and characteristics are expressly described in combination in this specification. The Applicant expressly intends such combinations of features and characteristics to be included within the scope of this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will comply with written description and sufficiency of description requirements (e.g., 35 U.S.C. §112(a)), and will not add new matter to the specification or claims. The processes and products disclosed in this specification can comprise, consist of, or consist essentially of the various features and characteristics described in this specification.

Also, any numerical range recited in this specification describes all sub-ranges of the same numerical precision (i.e., having the same number of specified digits) subsumed within the recited range. For example, a recited range of “1.0 to 10.0” describes all sub-ranges between (and including) the recited minimum value of 1.0 and the recited maximum value of 10.0, such as, for example, “2.4 to 7.6,” even if the range of “2.4 to 7.6” is not expressly recited in the text of the specification. Accordingly, the Applicant reserves the right to amend this specification, including the claims, to expressly recite any sub-range of the same numerical precision subsumed within the ranges expressly recited in this specification. All such ranges are inherently described in this specification such that amending to expressly recite any such sub-ranges will comply with written description and sufficiency of description requirements (e.g., 35 U.S.C. §§112(a) and 132(a)), and will not add new matter to the specification or claims. Additionally, numerical parameters described in this specification should be construed in light of the number of reported significant digits, the numerical precision of the number, and by applying ordinary rounding techniques. It is also understood that numerical parameters described in this specification will necessarily possess the inherent variability characteristic of the underlying measurement techniques used to determine the numerical value of the parameter.

Any patent, publication, or other disclosure material identified in this specification is incorporated by reference into this specification in its entirety unless otherwise indicated, but only to the extent that the incorporated material does not conflict with existing descriptions, definitions, statements, or other disclosure material expressly set forth in this specification. As such, and to the extent necessary, the express disclosure as set forth in this specification supersedes any conflicting material incorporated by reference. Any material, or portion thereof, that is incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference.

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and can be employed or used in an implementation of the described processes, compositions, and products. Further, the use of a singular noun includes the plural, and the use of a plural noun includes the singular, unless the context of the usage requires otherwise.

What is claimed is:

1. A process for the production of a tube comprising:
deforming a corrosion resistant alloy plate to form a hollow cylindrical preform having a longitudinal seam region located between two abutting ends of the deformed plate;
welding the longitudinal seam region to join together the abutting ends; and
flowforming the hollow cylindrical preform to produce a corrosion resistant alloy tube.

2. The process of claim 1, wherein the hollow cylindrical preform is formed from the plate such that grains of the corrosion resistant alloy are substantially oriented in the longitudinal direction of the preform.

3. The process of claim 1, wherein deforming the corrosion resistant alloy plate to form the hollow cylindrical preform comprises roll bending the corrosion resistant alloy plate.

4. The process of claim 1, further comprising machining or grinding the corrosion resistant alloy plate to a flatness of ±0.020 inch (±0.508 mm), wherein the machining or grinding is performed before the deforming.

5. The process of claim 1, wherein the welding is performed in a nitrogen atmosphere.

6. The process of claim 1, wherein the welding is performed using a filler-less welding technique.

7. The process of claim 1, wherein the welding comprises laser welding the longitudinal seam region to join together the abutting ends.

8. The process of claim 7, wherein the laser welding is performed in a nitrogen atmosphere.

9. The process of claim 1, wherein the welding comprises tungsten inert gas welding (TIG), metal inert gas welding (MIG), or plasma arc welding.

10. The process of claim 1, wherein the welding is performed using a filler weld alloy that is the same as the alloy of the preform or is over-alloyed with at least one austenite stabilizing element.

11. The process of claim 1, further comprising radially expanding the welded hollow cylindrical preform before the flowforming.

12. The process of claim 11, wherein the welded hollow cylindrical preform is radially expanded by at least 0.5%.

13. The process of claim 1, further comprising removing weld kerf from the welded longitudinal seam region.

14. The process of claim 13, wherein removing weld kerf comprises burnishing or skiving the weld kerf.

15. The process of claim 1, further comprising annealing the welded hollow cylindrical preform after the welding and before the flowforming.

16. The process of claim 15, wherein the annealing comprises heating the preform to a surface temperature in the range of 1010° C. to 1177° C. (1850-2150° F.).

17. The process of claim 15, wherein the annealing recrystallizes at least a heat affected zone of the welded preform.

18. The process of claim 15, further comprising quenching the hollow cylindrical preform after the annealing.

19. The process of claim 18, wherein the preform is quenched from annealing temperature after no more than 30 minutes time-at-temperature.

20. The process of claim 18, wherein the quenching is performed at a cooling rate that prevents the precipitation of deleterious phases during the cooling.

21. The process of claim 18, wherein the quenching comprises water quenching.

22. The process of claim 1, wherein the flowforming comprises reverse flowforming.

23. The process of claim 1, comprising flowforming the hollow cylindrical preform at a cold working temperature to a reduction-of-area of 25% to 75%.

24. The process of claim 1, comprising flowforming the hollow cylindrical preform at a cold working temperature to a reduction-of-area of 30% to 65%.

25. The process of claim 1, flowforming the hollow cylindrical preform in a single pass to produce the corrosion resistant alloy tube.

26. The process of claim 1, further comprising annealing the flowformed tube.

27. The process of claim 1, wherein the corrosion resistant alloy comprises a martensitic stainless steel, a martensitic/ferritic stainless steel, a duplex stainless steel, a super duplex stainless steel, a hyper duplex stainless steel, an austenitic stainless steel, an austenitic nickel base alloy, an austenitic nickel base superalloy, or a titanium base alloy.

28. The process of claim 1, wherein the corrosion resistant alloy comprises a duplex stainless steel, a super duplex stainless steel, or a hyper duplex stainless steel.

29. The process of claim 1, wherein the corrosion resistant alloy comprises a super duplex stainless steel having a volume fraction of ferrite ranging from 35% to 55%, or a duplex stainless steel having a volume fraction of ferrite ranging from 40% to 60%.

30. The process of claim 1, wherein the corrosion resistant alloy comprises a nickel base alloy or a titanium base alloy.

31. A tube produced by the process of claim 1.

32. The tube of claim 31, wherein the tube has a yield strength of 110-160 ksi (758-1,103 MPa).

33. The tube of claim 31, wherein the tube has an ultimate tensile strength of at least 125 ksi (862 MPa).

34. The tube of claim 31, wherein the ultimate tensile strength of the tube is at least 10 ksi (70 MPa) greater than the yield strength.

35. The tube of claim 31, wherein the tube has an elongation of at least 9%.

36. The tube of claim 31, wherein the tube has a yield strength of at least 125 ksi (862 MPa), an ultimate tensile strength of at least 130 ksi (896 MPa), an elongation of at least 10%, and an HRC hardness number no greater than 37.

37. The tube of claim 31, wherein the tube has an outside diameter of at least 7.0 inches (177.8 mm), wall thickness of at least 0.231 inches (5.87 mm), and a length of at least 34.0 feet (10.4 meters).

38. The tube of claim 31, wherein the tube has an outside diameter of at least 9.625 inches (244.5 mm), wall thickness of at least 0.312 inches (7.92 mm), and a length of at least 36.0 feet (11.0 meters).

39. The tube of claim 31, wherein the corrosion resistant alloy comprises a super duplex stainless steel having a volume fraction of ferrite ranging from 35% to 55%, or a duplex stainless steel having a volume fraction of ferrite ranging from 40% to 60%, and wherein the tube has a yield strength of at least 110 ksi (758 MPa), an ultimate tensile strength of at least 125 ksi (862 MPa), an elongation of at least 9%, and an HRC hardness number no greater than 38.

40. The tube of claim 31, wherein the tube complies with ANSI/API Specification 5CRA, first edition, February 2010.

41. A process for the production of a tube comprising:
deforming a stainless steel plate to form a hollow cylindrical preform having a longitudinal seam region located between two abutting ends of the deformed plate, the stainless steel comprising a duplex, super duplex, or hyper duplex stainless steel;
laser welding the longitudinal seam region to join together the abutting ends;
annealing the laser welded preform; and
reverse flowforming the laser welded hollow cylindrical preform at a cold working temperature to produce a stainless steel tube.
